(19) United States
(12) Patent Application Publication
(10) Pub. No.: US 2026/0147344 A1
(43) Pub. Date: May 28, 2026

(54) METHODS AND SYSTEMS FOR COORDINATING MOTION OF AUTONOMOUS AGENTS

(71) Applicant: Coordinai Inc., Somerville, MA (US)

(72) Inventor: Fernando Tubilla Kuri, Milton, MA (US)

(21) Appl. No.: 19/396,943

(22) Filed: Nov. 21, 2025

Related U.S. Application Data
(60) Provisional application No. 63/724,176, filed on Nov. 22, 2024.

(51) Int. Cl. G05D 1/227; G05D 1/225; G05D 1/698; G05D 101/00; G05D 107/70; G06Q 10/087

(52) U.S. Cl. CPC G05D 1/2272; G05D 1/225; G05D 1/6987; G06Q 10/08743; G05D 2101/22; G05D 2107/70

(57) ABSTRACT

Scalable methods and systems include coordinating in real-time, the motion in a mapped environment of large groups of autonomous agents. The agents and machines may include autonomous mobile robots (AMRs) used in logistics and manufacturing, autonomous vehicles, drones, humanoids robots, or characters in a computer simulation or game. A coordinator server may periodically determine, during a polling period, a current location, velocity, and target destination of agents. The coordinator server may issue a sequence of travel commands for the agents to execute until the next polling period. In some implementations, the coordinator server is configured with an iterative pathfinding process to generate paths for the agents sequentially. The generated path of an agent at an iteration respects reservations in space-time made by previous agents in the same iteration and by other agents in the previous iteration. The computation of such paths can be distributed among one or more processors for scaling to large fleets of agents.

### CROSS-REFERENCE TO RELATED APPLICATIONS

This application claims priority to U.S. Provisional Application No. 63/724,176, titled Methods for Coordinating the Motion of Large Groups of Autonomous Agents in Real-Time, filed Nov. 22, 2024, which is hereby incorporated by reference in its entirety.

### FIELD OF DISCLOSURE

In some aspects, the techniques described herein relate to a real-time route planning coordination system for autonomous agents.

### BACKGROUND

Traditional methods of allocating motion paths to agents (e.g., robots) make local decisions and fail to coordinate motion proactively. In one simplified method, an agent requests a travel path from a controller, which computes the path by performing a shortest-path search (typically using a pathfinding algorithm) on a graph-representation of the environment. The search in this simplified method finds paths that avoid known static obstacles in the environment (e.g., a column or a wall) as well other agents that have remained static for a long enough period (e.g., a disabled robot) but it is performed independently and without awareness of path requests or intended travel paths from other agents. A reservation control system is then responsible for granting access to a small segment along this path so that the agent can safely move without collisions. In the case that it is not possible to grant a segment of the requested path due to, e.g., conflicts with other existing reservations, the agent will have to either wait and retry or request an alternate path, a condition referred to as reactive replanning.

Reactive replanning is often used to overcome the deficiencies of independent path finding but it can lead to increased floor congestion, gridlock, and variability in travel times, particularly in dense systems (i.e., many agents per unit of space). A cooperative approach that aims to reduce replanning incorporates into each agent's path search knowledge of existing reservations, allowing the agent to plan around existing reservations. However, the resulting paths are still not sufficiently coordinated because each path is calculated with limited knowledge of the intended paths of all agents, not just those that have already secured path reservations. Moreover, without the ability to change previously made reservations, it may not be possible in general to find a feasible path for an agent.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Scalable methods and systems include coordinating in real-time, the motion in a mapped environment of large groups of autonomous mobile agents. The agents or autonomous mobile machines may include autonomous mobile robots (AMRs) used in logistics and manufacturing, autonomous vehicles, humanoids, drones, or characters in a computer simulation or game. A coordinator server may periodically determine, during a polling period or in response to some event, a current location, velocity, and target destination of agents. The coordinator server may issue a sequence of travel commands for the agents to execute until the next polling period. In some implementations, the coordinator server is configured with an iterative pathfinding process that generates paths for the agents sequentially. The generated path of an agent at an iteration respects reservations in space-time made by previous agents in the same iteration and by other agents in the previous iteration. The computation of such paths can be distributed among one or more processors for scaling to large fleets of agents.

In some aspects, the techniques described herein relate to a method of operating a route planning system for autonomous mobile machines, including: receiving, at a warehouse server, a plurality of states and tasks assigned to a plurality of autonomous mobile machines; transmitting from the warehouse server to a coordinator server, the plurality of states and tasks assigned to the plurality of autonomous mobile machines; receiving at the coordinator server, the plurality of states and tasks assigned to the plurality of autonomous mobile machines; initializing, at the coordinator server, at least two reservation manager objects; iteratively determining paths for one or more of the plurality of autonomous mobile machines, wherein paths for at least one iteration are used to determine paths for a later iteration; storing in at least one of the at least two reservation manager objects, a set of paths for one or more of the plurality of autonomous mobile machines that were iteratively determined; transmitting the set of paths for the one or more of the plurality of autonomous mobile machines from the coordinator server to the warehouse server; transmitting from the warehouse server to the one or more of the plurality of autonomous mobile machines, the set of paths; causing the one or more of the plurality of autonomous mobile machines to move in accordance with the set of paths for at least one time period.

In some aspects, the techniques described herein relate to a method, wherein the tasks may include a target destination and task priority.

In some aspects, the techniques described herein relate to a method, wherein a reservation manager object of the at least two reservation manager objects includes a map of reserved states and times of one or more of the plurality of autonomous mobile machines.

In some aspects, the techniques described herein relate to a method, wherein the reservation manager objects include maps of reserved states and times of one or more of the plurality of autonomous mobile machines for different iterations of determining paths for the one or more of the plurality of autonomous mobile machines.

In some aspects, the techniques described herein relate to a method, wherein one of the at least two reservation manager objects is a working reservation manager object and the other of the at least two reservation manager objects is a reference reservation manager object.

In some aspects, the techniques described herein relate to a method, wherein the working reservation manager object includes newly made reservations associated with the plurality of autonomous mobile machines and the reference reservation manager object includes previously made reservations associated with the plurality of autonomous mobile machines.

In some aspects, the techniques described herein relate to a method, further including: iteratively determining, new paths for one or more of the plurality of autonomous mobile machines for a new planning horizon, wherein the new paths take into account the one or more prior paths determined in prior iterations of the new planning horizon for the one or more of the plurality of autonomous mobile machines; storing in one of the at least two reservation manager objects, a set of new paths for the one or more of the plurality of autonomous mobile machines; transmitting the determined the set of new paths from the coordinator server to the warehouse server; transmitting from the warehouse server to the one or more of the plurality of autonomous mobile machines, the set of new paths; causing the one or more of the plurality of autonomous mobile machines to move in accordance with the set of new paths.

In some aspects, the techniques described herein relate to a method, wherein iteratively determining the set of paths for the one or more of the plurality of autonomous mobile machines further includes determining the paths for fewer than all of the one or more of the plurality of autonomous mobile machines.

In some aspects, the techniques described herein relate to a method, wherein the iterative determination of the paths is stopped after a predetermined threshold quantity of iterations.

In some aspects, the techniques described herein relate to a method, wherein when a non-conflicting path is not determined for an autonomous mobile machine of the one or more of the plurality of autonomous mobile machines, a previously determined non-conflicting path is assigned to the autonomous mobile machine.

In some aspects, the techniques described herein relate to a method, wherein the iterative determination of the paths is stopped when no conflicting paths remain.

In some aspects, the techniques described herein relate to a method, further including: iteratively determining, new paths for one or more of the plurality of autonomous mobile machines for a new planning horizon, wherein the new paths take into account the one or more prior paths determined in prior iterations of the new planning horizon for the one or more of the plurality of autonomous mobile machines; storing in one of the at least two reservation manager objects, a set of new paths for the one or more of the plurality of autonomous mobile machines; transmitting the set of new paths from the coordinator server to the warehouse server; transmitting from the warehouse server to the one or more of the plurality of autonomous mobile machines, one or more movement commands in accordance with the set of new paths.

In some aspects, the techniques described herein relate to a method of scaling operation of a route planning system for autonomous mobile machines, including: determining a size of an environment for a plurality of autonomous mobile machines at a distributed coordinator server; partitioning, at the distributed coordinator server, the environment for the plurality of autonomous mobile machines in accordance with predetermined criteria into a plurality of subset environments; for at least one of the plurality of subset environments: receiving, at a warehouse server for a subset environment of the plurality of subset environments, a plurality of states and tasks assigned to the plurality of autonomous mobile machines for the subset environment, and transmitting from the warehouse server for the subset environment to a distributed coordinator server, the plurality of states and tasks assigned to the plurality of autonomous mobile machines. The techniques may further comprise receiving at the distributed coordinator server, the plurality of states and tasks assigned to the plurality of autonomous mobile machines of the subset environment; initializing, at the distributed coordinator server, at least two reservation manager objects for the subset environment; iteratively determining paths for one or more of the plurality of autonomous mobile machines for the subset environment; storing in one of the at least two reservation manager objects, a set of paths for one or more of the plurality of autonomous mobile machines for the subset environment; transmitting the set of paths from the coordinator server to the warehouse server of the subset environment; transmitting from the warehouse server of the subset environment to the one or more of the plurality of autonomous mobile machines within the subset environments, the set of paths for the subset environments; and causing the one or more of the plurality of autonomous mobile machines within the subset environments to move in accordance with the set of paths.

In some aspects, the techniques described herein relate to a method of scaling operation of a route planning system for autonomous mobile machine, including: determining a size of an environment for a plurality of autonomous mobile machines at a distributed coordinator server; partitioning, at the distributed coordinator server, the environment for the plurality of autonomous mobile machines in accordance with predetermined criteria into a plurality of subset environments; for at least two of the plurality of subset environments: receiving, at a warehouse server, a plurality of states and tasks assigned to the plurality of autonomous mobile machines, and transmitting from the warehouse server to a distributed coordinator server, the plurality of states and tasks assigned to the plurality of autonomous mobile machines; receiving at the distributed coordinator server, the plurality of states and tasks assigned to the plurality of autonomous mobile machines for the at least two of the plurality of subset environments; initializing, at the distributed coordinator server, a plurality of reservation manager objects for each of the at least two of the plurality of subset environments and a concurrent reservation manager to be shared among the plurality of subset environments; iteratively determining paths for one or more of the plurality of autonomous mobile machines for the at least two of the plurality of subset environments; storing in a reservation manager object for each of the at least two of the plurality of subset environments and the concurrent reservation manager object, the a first set of paths for one or more of the plurality of autonomous mobile machines associated with a first one of the at least two of the plurality of subset environments and a second set of paths for one or more of the plurality of autonomous mobile machines associated with a second one of the at least two of the plurality of subset environments; transmitting the first set of paths and the second set of paths from the distributed coordinator server to the warehouse server for at least two of the plurality of subset environments; transmitting the first set of paths from the warehouse server to the one or more of the plurality of autonomous mobile machines associated with the first one of the at least two of the plurality of subset environments and transmitting the second set of paths from the warehouse server to the one or more of the plurality of autonomous mobile machines associated with the second one of the at least two of the plurality of subset environments; and causing the one or more of the plurality of autonomous mobile machines associated with the first one of the at least two of the plurality of subset environments to move in accordance with the first set of paths and the one or more of the plurality of autonomous mobile machines associated with the second one of the at least two of the plurality of subset environments to move in accordance with the second set of paths.

In some aspects, the techniques described herein relate to a route planning system for autonomous mobile machines, including: a processor; and a memory device that stores a plurality of instructions, which when executed by the processor, causes the processor to be configured to: receive, from a warehouse server, a plurality of states and tasks assigned to a plurality of autonomous mobile machines; initialize at least two reservation manager objects; iteratively determine paths for one or more of the plurality of autonomous mobile machines for a first planning horizon; store in at least one of the at least two reservation manager objects, a set of paths for one or more of the plurality of autonomous mobile machines for the first planning horizon; transmit the set of paths from to the warehouse server to cause the one or more of the plurality of autonomous mobile machines to move in accordance with the set of paths for at least one time period within the first planning horizon.

In some aspects, the techniques described herein relate to a route planning system, wherein the tasks may include a target destination and task priority for the plurality of autonomous mobile machines.

In some aspects, the techniques described herein relate to a route planning system, wherein a reservation manager object of the at least two reservation manager objects includes a map of reserved states and times of the plurality of autonomous mobile machines.

In some aspects, the techniques described herein relate to a route planning system, wherein one of the at least two reservation manager objects is a working reservation manager object and the other of the at least two reservation manager objects is a reference reservation manager object.

In some aspects, the techniques described herein relate to a route planning system, wherein the working reservation manager object includes newly made reservations associated with the plurality of autonomous mobile machines and the reference reservation manager object includes previously made reservations associated with the plurality of autonomous mobile machines.

In some aspects, the techniques described herein relate to a route planning system, wherein the plurality of instructions further causes the processor to: iteratively determine, new paths for one or more of the plurality of autonomous mobile machines for a second planning horizon, wherein the new paths take into account the one or more prior paths of the second planning horizon for the one or more of the plurality of autonomous mobile machines; store in one of the at least two reservation manager objects, a set of new paths for the one or more of the plurality of autonomous mobile machines; and transmit the set of new paths from the coordinator server to the warehouse server to cause the one or more of the plurality of autonomous mobile machines to move in accordance with the set of new paths for the second planning horizon.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is an example illustration of an agent on a 2D grid with state defined by its center-point coordinates and orientation, according to some implementations of the present disclosure.

FIG. 2 is a flowchart of an example path finder process 200 for determining a path connecting an origin state and target state and that avoids conflicts with reservations from one or more reservation managers according to some implementations of the present disclosure.

FIG. 3 is a flowchart of an example Base Planner process 300 of a base planner system for agents according to some implementations of the present disclosure.

FIG. 4 is an example illustration of conflict scenarios between a plurality of agents according to some implementations of the present disclosure.

FIG. 5 illustrates an example of the paths that can be generated by the coordinator server using a base planner process for four agents over three iterations of the base planner process according to some implementations of the present disclosure.

FIG. 6 is an example illustration of distributed planning for many agents across large areas.

FIG. 7 is a flowchart of an example distributed planner process 700 of a distributed planner system for a plurality of agents according to some implementations of the present disclosure.

FIG. 8 is a flowchart of an example process 800 incorporating a base planning system into a distributed planning system for a plurality of agents according to some implementations of the present disclosure.

FIG. 9 is an example communication process diagram between a coordinator server, robot managers, and robot agents according to some implementations of the present disclosure.

FIG. 10 is an example snapshot of a discrete-event simulation of an automated cross-dock warehouse with an open floor, with inbound stations on the left, and outbound stations on the right, according to some implementations of the present disclosure.

FIG. 11 is an example snapshot of a discrete-event simulation of the same cross-dock warehouse but operated under a traditional, independent motion planning system as described in the Background, illustrating the formation of gridlock at one of the pick stations, according to some implementations of the present disclosure.

FIG. 12 is an example snapshot of a discrete-event simulation of a larger cross-dock warehouse than shown in FIG. 10 and FIG. 11 operated using the distributed planner process 700, with the floor partitioned into four sub-grids, according to some implementations of the present disclosure.

FIG. 13A is an example snapshot of a discrete-event simulation model of a sortation system with item receiving points on the lower edge of the building and item ejection points on opposite sides of the building.

FIG. 13B shows an example graph of system throughput, comparing performance when running with a traditional, independent planning system as described in the Background section of this disclosure against an output of a coordination system according to some implementations of the present disclosure.

FIG. 14 illustrates a schematic of a cross dock where AMRs are used for transporting pallets from the receiving to the shipping port, according to some implementations of the present disclosure.

FIG. 15 illustrates an example of a coordination planning system according to some implementations of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Various systems and methods for generating scalable proactively coordinated motion of a plurality of autonomous agents with high precision control are described herein. The benefits of such systems and methods go beyond reducing congestion and preventing gridlock, which are issues in high agent density environments, such as those found in fulfillment centers with large AMR fleets. High precision motion coordination enables a finer degree of control on the sequence of arrivals of agents to a common destination (e.g., a pick or assembly station) thus allowing the precise ordering of products when assembling, e.g., a customer order, a manufacturing product, or when loading a delivery truck. In reconfigurable manufacturing systems, coordinated motion of mobile robots is needed for rapidly achieving the desired arrangement of machines, tooling, and inventory buffers. Coordinated motion is also beneficial for the smooth execution of ancillary operations that support multi-agent systems, such as charging a set of robots or parking a group of autonomous vehicles. Without a coordination system as disclosed herein, system operators need to manually handcraft a set of rules and pathways and manually adjust the motion of agents to impose order in an otherwise chaotic system. These rules, however, are not easy to define and often lead to sub-optimal performance (e.g., low material throughput), brittle systems (e.g., systems prone to disruption or gridlock), and unnecessary congestion.

The coordination problem that the present disclosure addresses has its theoretical foundations in the multi-agent path finding (“MAPF”) problem. The MAPF problem has been studied in multiple contexts, including for robotics, aviation, vehicle routing, supply network flow optimization, and video games. In its simplest form, MAPF problem can be described as follows. There are k agents located in an undirected graph G=(V, E), where V denotes the set of vertexes and E denotes the set of edges of the graph. Time is discretized, and at individual time steps, an agent can either stay at its current vertex (e.g., its current position) or move to an adjacent vertex, completing a motion by the following time step. The initial state sₖ and target goal gₖ are specified for agents k. For example, for an agent that moves in 2D space, the initial state sₖ could be represented by the coordinates of the center point of the agent and an angle denoting its orientation. A single-agent motion plan πₖ for agent k may comprise a sequence of actions (a₀, ..., aₙ₋₁) executed by the agent at time steps t=0, . . . , n−1 such that, if xₖ(t) denotes the position of agent k at time t, then xₖ(0)=sₖ and xₖ(n)=gₖ. The set of states {xₖ(0), xₖ(1), . . . , xₖ(n)} is referred to as a path, and a valid solution to the MAPF problem comprises a set of conflict-free, single-agent motion paths (e.g., conflict-free paths of different agents).

One source of conflicts may arise when two agents, such as k and k′, occupy the same location at the same time step (e.g., xₖ(t)=x_{k′}(t)). Other types of conflicts can be considered depending on the agent kinematics, including swapping or head-to-head conflicts (e.g., when xₖ(t+1)=x_{k′}(t) and xₖ(t)=x_{k′}(t+1)) and following conflicts (e.g., when xₖ(t+1)=x_{k′}(t)). An optimal solution for the MAPF problem may include one that achieves the minimal value for some objective function; two such functions that are common in the literature are the makespan function (represented as maxᵢ|πᵢ|) and the sum of costs function (represented as Σᵢ|πᵢ|).

Most of the current research on the MAPF problem focuses on algorithms that are either provably correct but have no solution-quality guarantees or exact algorithms that can find an optimal solution but do not scale to industrial-sized instances (such as in a warehouse environment, where there may be several hundred or more mobile robots). For industrial scenarios, a variety of search-based optimal solvers have been developed. Techniques range from using the A* search algorithm on the coupled action space of the robots with modifications to reduce the size of the explored nodes to approaches that start with a decoupled search and grow the search space as needed to resolve conflicts. Another example is a constraint based search (CBS) algorithm that, rather than searching over a joint action space directly, employs a search tree where nodes correspond to a set of (possibly conflicting) paths for k agents, and a non-solution node will branch into two children by enforcing a constraint that resolves one of the conflicts present in the parent node's paths. Through subsequent enhancements to its initial formulation, CBS constitutes a state-of-the-art algorithm for finding optimal solutions to the MAPF problem.

While the above mentioned MAPF solutions capture a portion of the path-coordination complexity in real systems, these MAPF solutions makes several important simplifications. For example, the above mentioned MAPF solutions make an assumption that all agent motion is synchronized, with all agents selecting and completing their next action within the same time step, irrespective of acceleration/deceleration limitations. The above-mentioned MAPF solutions also assume that the problem is static and deterministic (e.g., all target locations are known in advance, and no disruptions or new targets will emerge over time). Recent research has begun to address some of these limitations, including the development of an optimal search algorithm for continuous-time MAPF and so-called lifelong MAPF formulations where new tasks emerge over time and the objective consists of maximizing the throughput or rate of task completion. However, existing solutions still do not meet the scalability needs of industrial-sized instances with fleets of agents.

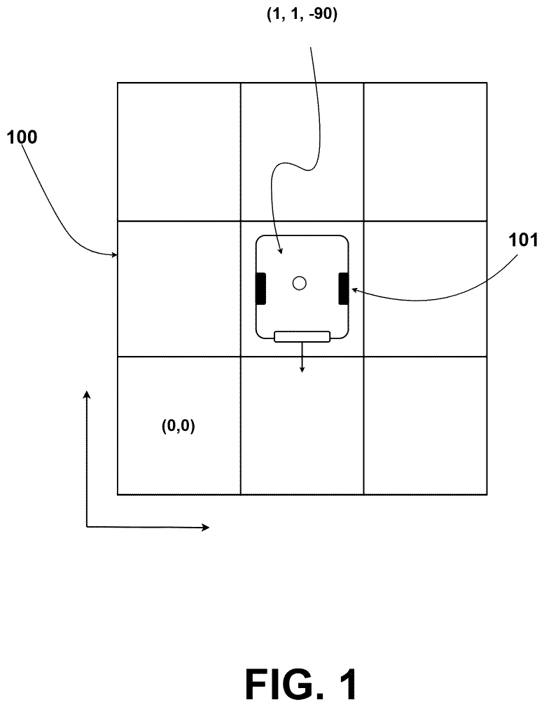

The improved coordination planning systems and methods disclosed herein solve the above-mentioned shortcomings. In some implementations, the improved coordination planning systems and methods disclosed herein coordinate motion along a mapped environment, represented as an undirected graph G=(V_{M}, E_{M}) where V_{M} is the set of vertexes of the graph G and E_{M} is the set of edges of the graph G. In one implementation of the coordination planning system, G represents a regular grid in two-dimensional (2D) space. In this case, a vertex (x, y) could correspond to, e.g., the center point of one grid cell and the vertex could be connected to one or more of its 8 neighbors, provided those neighboring cells are not blocked by a static obstacle such as a wall, a workstation, or a column and the one grid cell is not adjacent to one or more edges of the graph G. To represent agent states, the environment graph G can be expanded based on the agents'motion kinematics to form a state-space graph S=(V_{S}, E_{S}), where V_{S} is the set of agent states and ES is the set of edges connecting pairs of states that have a valid transition. For example, FIG. 1 illustrates a simple graph G with grid 100 depicting an implementation of a 2D-grid environment and the state (x, y, θ) denotes the coordinates of agent 101 (e.g., an AMR or other suitable agent) cell location in the grid and the orientation of agent 101. As shown in FIG. 1, agent 101 is located at cell (1, 1) and with an angle orientation θ of −90 degrees (i.e., pointing downward). In some cases, the motion of agents operating in such a grid can be restricted to forward motion and in-place rotation (e.g., a non-holonomic agent). Thus, valid edges in the state-space graph may be present to connect state (x, y, θ) with the neighboring state at the cell directly in front of an agent (in the example of FIG. 1, the state (x, y−1, θ)) as well as with states at the current cell with the same or different orientation, to represent waiting and rotation actions (respectively). In some implementations, other attributes can be included in the state representation, such as the agent's current linear and angular velocity, which can be used for accounting for, e.g., finite acceleration/deceleration effects. In such cases having additional agent attributes, the velocities of an agent may be quantized to maintain a discrete representation of the state embedded on the graph S. For example, suppose the 2D-grid environment in FIG. 1 has cell dimensions of 1 meter on each side. If agent 101 can achieve an acceleration/deceleration of 1 m/s² and has a top velocity of 2 m/s, the velocity at the vertexes in the state-space graph S could be set to one of the discrete set of values {0, 1.4142, 2}, assuming the robot accelerates fully until reaching the top velocity.

In some implementations, the planning horizon of the coordination planning system disclosed herein can be discretized at regular points in time t₀, t₁, . . . , t_{T}, where Δ=tᵢ−tᵢ−1 is the time discretization interval, for 0<i≤T. In some implementations, the discretization interval Δ is large enough that the time it takes to move from one state to a neighboring state in a grid is no greater than Δ. This ensures that the state of the agents can be mapped to a vertex in the state-space graph G at periods t₀ to t_{T}.

In some implementations, the coordination planning system plans in continuous time and may keep track of the transition start and end times between two contiguous states of an agent to determine potential conflicts. For example, a transition between states (0, 0, 0) and (1, 0, 0) for an agent may occur between (continuous) time instants t₀ and t₁, respectively. The length of the time interval can be estimated based on the agent's kinematics, including its acceleration/deceleration profile and its current velocity.

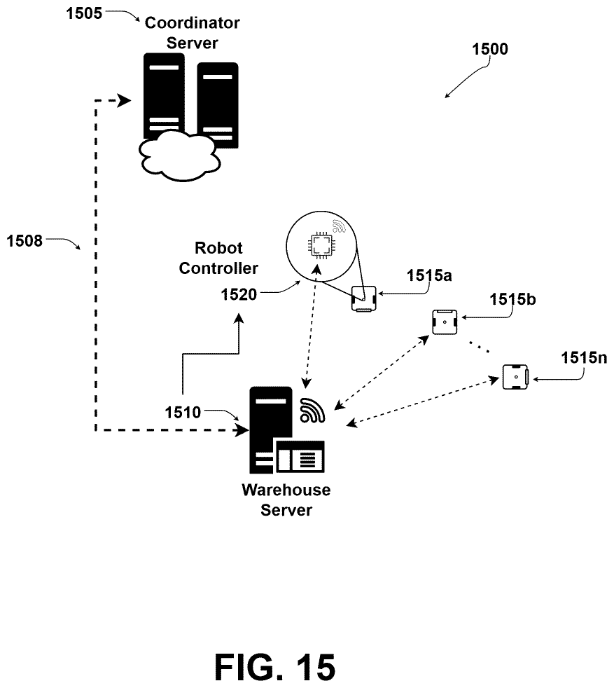

FIG. 15 illustrates an example system architecture diagram of a coordination planning system 1500 for autonomous agents according to some implementations of the present disclosure. The coordination planning system 1500 can comprise a coordinator server 1505 that communicates with a warehouse server 1510 to coordinate motion paths for a plurality of autonomous agents. The communication link 1508 between coordinator server 1505 and warehouse server 1510 can be via suitable communication connections (e.g., directly, indirect, hardwire, wireless, satellite, terrestrial, etc.). As illustrated, coordination planning system 1500 may include a plurality of agents such as agent 1515a, agent 1515b, through agent 1515n, representing a fleet of autonomous mobile machines operating within the coordinated environment. The coordination planning system 1500 can support any suitable quantity of agents. In addition, agents may include a controller such as robot controller 1520, which serves as an interface between the warehouse server 1510 and the individual agents, managing the execution of movement commands at the machine level.

The system architecture enables concurrent motion planning of many autonomous agents while maintaining coordination through a centralized planning approach. In some implementations, the robot controller 1520 may handle low-level motion control and safety functions for individual agents while receiving high-level path commands from the warehouse server 1510. The coordination planning system 1500 illustrates the hierarchical communication structure that enables scalable coordination of autonomous mobile machines in industrial environments such as warehouses, manufacturing facilities, or distribution centers. It should be appreciated that the coordination planning system 1500 can be used in other suitable locations or situations where coordination planning is useful.

In some implementations, the coordination planning systems and methods (e.g., coordination planning system 1500) disclosed herein comprise, in their most basic form, a coordinator server (e.g., coordinator server 1505) including a Path Finder system and a Base Planner system, which are described in more detail below. In some implementations, the coordinator server may further include a Distributed Planner system that enables scaling the system for coordinated planning to instances with large fleets of agents. In some implementations, the Base Planner system uses the Path Finder system to find a conflict-free travel path for a given agent k from its current state sₖ in graph S to a goal state gₖ in graph S.

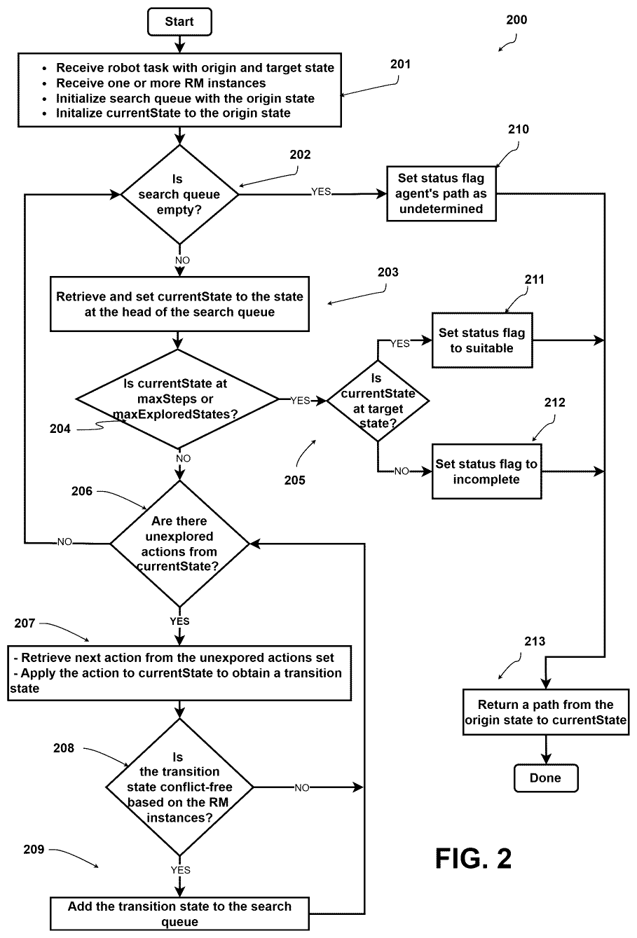

FIG. 2. illustrates a flow diagram for the Path Finder process 200, which finds a feasible path between an origin state and a target state. The Path Finder process 200 may be executed by a coordinator server (e.g., coordinator server 1505). The Path Finder process 200 may conduct a search in state-space and time, where state-space is discretized according to the grid S and time may be discretized or treated as a continuous variable as described above. As illustrated in block 201, the coordinator server executing the Path Finder process 200 receives, for a particular agent, an agent task to plan comprising an origin and a target state. The origin state is the current state (e.g., the position) of the agent and the target state is the final state (e.g., end position) that the agent aims to reach in a graph S. In some implementations, the origin state could be a projected state of the agent, wherein the projected state could be used in a situation where there is computational lag from Path Finder process 200 or other processes handled by the coordinator server. The coordinator server may receive one or more reservation manager objects used for determining conflicts, wherein a reservation manager object may comprise data structures which store existing reservations of one or more agents in state-space-time. The coordinator server may create and update a working reservation manager object and a reference reservation manager object. In some implementations with multiple reservation managers, the coordinator server may create and update concurrent reference manager objects corresponding to the multiple reservation managers objects. As also illustrated in block 201, the coordinator server may initialize a search queue with the received origin state and initialize a currentState variable to the origin state of the agent. In some implementations, the coordinator server may initialize the search queue and the currentState variable at a later time in Path Finder process 200.

In some implementations, the coordinator server using Path Finder process 200 may include initialization of software objects in memory to support the pathfinding operations. The coordinator server may allocate memory space for the working reservation manager object, which may be implemented as a data structure that maintains mappings between spatial locations, time intervals, and agent identifiers. The working reservation manager object may be stored in volatile memory such as RAM or cache memory to enable rapid access during path computation. Similarly, the reference reservation manager object and the search queue may be initialized as a separate software object in memory, maintaining its own data structures for storing previously computed agent reservations from prior iterations. The initialization process may include setting default values for object properties, establishing data structure relationships between different software objects, and configuring memory access patterns to optimize performance during concurrent operations.

In some implementations, the Path Finder process 200 may use a modified A* search algorithm to find clear paths for the agents. In an A* search algorithm, the search queue can be populated with states that are yet to be visited by agents, and the states in this queue can be ordered by their estimated value, so that partial paths that have a higher value (or lower cost) are explored first. As illustrated in block 202, the coordinator server determines if the search queue is empty. In some implementations, block 202 is skipped once after initialization because an initialized search queue generally will be populated with at least the origin state of an agent. The coordinator server may explore available motion paths for an agent based on a current state of the agent. As part of exploring the available motion paths for an agent, as illustrated in block 203, the coordinator may retrieve and set the currentState variable to the state listed at the head of the search queue. As noted above, the search queue can be ordered based on values assigned to the states, where the current head of the queue may be associated with the highest value state. The head of the queue can be associated with a value other than the highest value in some implementations. When viewing Path Finder process 200 in the process loop shown from block 202-209, it should be apparent that states from the search queue can be explored one at a time by extracting the head of the search queue (as shown in block 203) and until the queue is empty, a condition that is checked in block 202. As illustrated in block 204, the coordinator server checks if a stop condition has been met. In some implementations, the stopping condition includes determining whether a maximum number of steps or a maximum number of explored states (e.g., maxExploredStates) have been explored for an agent. It should be appreciated that other suitable thresholds can be assigned to the stopping condition. Steps are movement actions that an agent can take to reach its intended target state. Explored states comprise the states that have been retrieved from the search queue in block 203. The maximum number of steps or a maximum number of explored states threshold can be any suitable quantity. As is noted below, the maxExploredStates threshold can be set to 250. It should be appreciated that as the threshold is set to higher values, the coordinator server may engage in greater computational cycles to arrive at a set of nonconflicting motion paths for a given agent. If a stopping condition at block 204 has not been met, the coordinator server can explore transitions from the current state of the agent to neighboring states.

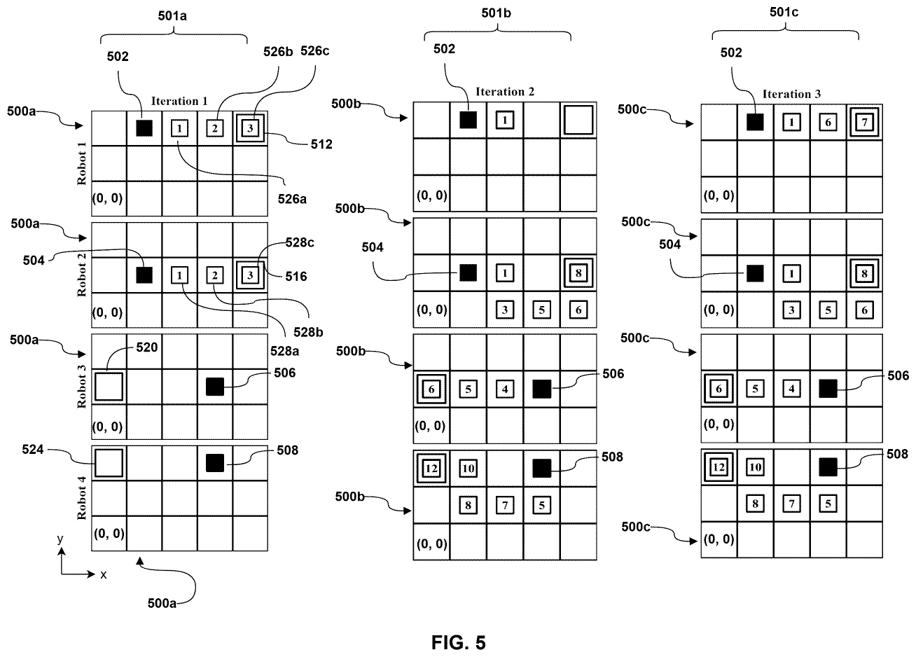

As illustrated in block 206, the coordinator server may determine if there are potentially unexplored next actions available for the agent, which are available paths for the agent to move for a given time frame (e.g., move forward, move right, move left, move backwards, rotate in place, wait, etc.). If there are unexplored actions, as illustrated at block 207, the coordinator server can retrieve an action for an agent from a set of available actions. In some implementations, the set of available next actions may depend on the orientation of the agent. For example, moving in a different direction than the current orientation of the agent may cause an agent to first rotate to a new orientation in the given time step and then attempt to move in the new direction in a later time step. For example, if an agent is oriented to move forward and an unexplored action is to move left, the coordinator server may determine that a next action is to rotate to the new orientation before the agent can move left as a subsequent action in a later time step. As also illustrated at block 207, the coordinator server may set the agent's transition state (e.g., a potential next state from the current state) based on the retrieved unexplored action. The transition states will be determined by the set of valid actions that the agent can apply starting from the current state (e.g., move forward, rotate, wait, etc.). Example valid actions for agent 502 in first iteration grid 500a of FIG. 5 include moving forward one grid segment (2, 2) or rotating in place (1, 2) to be positioned to move down one grid segment (1, 1). Example transition states for an agent 502 moving forward in one direction can be seen with the sequential valid actions from agent state 526a, agent state 526b, and agent state 526c in FIG. 5, which represents agent 502 moving across the grid segments in different time steps to target state 512 in the first iteration grid 500a. In some implementations, a single transition state may include rotating in place or waiting. An example of an agent having a transition state of moving forward in time step 1, a transition state of rotating in time step 2, and a transition state of moving forward in time step 3 can be seen with robot two 504 in second iteration grid 500b in FIG. 5. The transition state of rotating in time step 2 is not visible because it occurs in the same grid segment as time step 1.

Returning to FIG. 2, the coordinator server may evaluate the transition state against the reservations in the one or more reservation manager objects provided to the coordinator server as illustrated at block 208. In some implementations, the conflict analysis may include checking one or more reservation manager objects for conflicts. In some implementations, the conflict analysis may include checking a working reservation manager object, a reference reservation manager object, and/or a concurrent reference reservation manager object to determine if the transition state (e.g., state resulting from the proposed next action for the agent could result in a conflict with another agent). As discussed below for the Base Planner process 300, the working reservation manager object provides the paths of agents that have been processed through the Path Finder process 200 for the next planning iteration (e.g., the outer loop the Base Planner process 300 starting at block 302) and their paths are loaded in the working reservation manager object. The reference reservation manager object provides determined paths of agents for the prior planning iteration, but where paths for such agents have not yet been processed through the Path Finder process 200 for the next planning iteration. In some implementations, the conflict analysis may include determining whether a payload (e.g., dimensions of the payload) carried by the agent could overlap with other adjacent segments or cells of graph S (which might cause a collision with another agent or another agent's payload).

If the transition state does not have any conflict, it is added to search queue for further exploration as illustrated at block 209. The transition state represents the state of an agent after moving per the retrieved action. The coordinator server may return to block 206 to repeat the determination of whether there are unexplored actions for an agent as shown in Path Finder process 200. If the coordinator server determines a conflict for an agent for the transition state, the transition state is not added to the search queue and the coordinator server returns to block 206 to repeat the determination of whether there are unexplored actions for the agent. If the coordinator server determines at block 206 that there are no unexplored actions for the agent, the coordinator server returns to block 202 to examine the motion paths for the agent from the search queue.

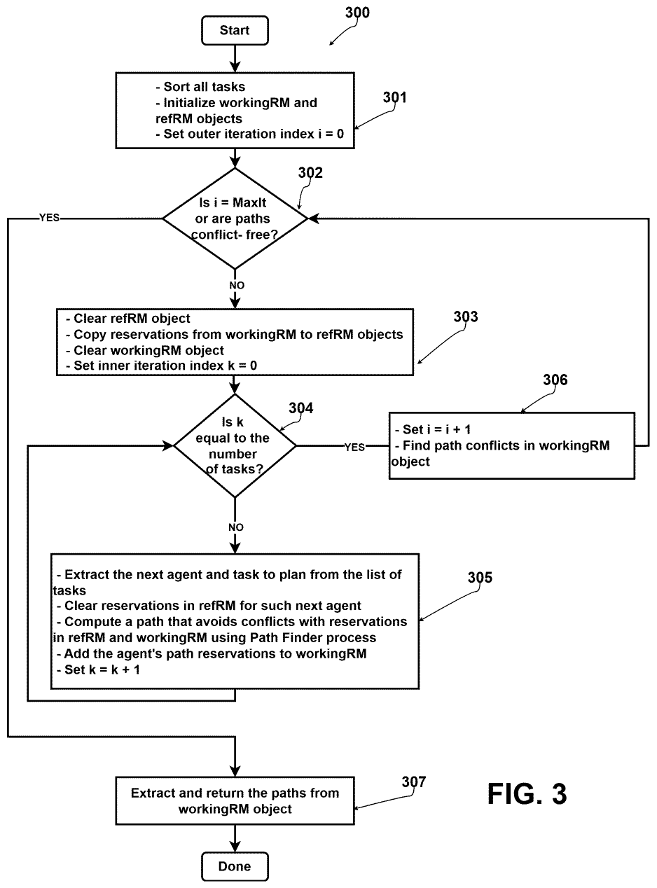

As shown at block 202, if the coordinator server determines that the search queue is empty without finding a solution for an agent's motion path, the coordinator server may flag that agent's motion path was not determined, as illustrated at block 210. For example, the coordinator server can set a reservation state status of the agent to “infeasible” or some other suitable flag or indicator. In some implementations, if such an indicator or flag is associated with an agent, the coordinator server may reserve the current location of the agent for the planning horizon so that additional iterations of the base planner for this same planning horizon can plan around this agent remaining in one place on a grid. If the stopping condition at block 204 is reached upon expansion of the next state, the state can be compared with the target state as in block 205 to determine if a suitable path has been found at block 211 or if the path is incomplete at block 212. In some implementations, if a suitable path has been found, the coordinator server may set a status flag to suitable or optimal for the path determined for the agent. Any suitable flag can be set to indicate that a suitable path had been found with the Path Finder process 200. In some implementations, if a suitable path has not been found, the coordinator server may set a status flag to be incomplete for the path determined for the agent. Any suitable flag can be set to indicate that the path determination for the agent is incomplete. Once the search concludes, a path or other path status for an agent from the origin state to the target state (or final state, in the case of incomplete paths) can be returned or provided to a Base Planner process as shown in block 213. The Base Planner process is described in more detail below in FIG. 3. In some implementations, a path for an agent can be constructed by tracing backwards the sequence of actions that led to the final state determined using the coordinator server using the Path Finder process 200.

The Path Finder process 200 for coordinator server can be configured to explore a certain quantity of potential future transition states of agents within the graph S (e.g., a planning horizon). The planning horizon for the Path Finder process 200 for the coordinator server can be specified as a number of transition states in any path for an agent (e.g., maxSteps), a planning horizon time T (not shown in FIG. 2, but useful when the time duration of individual transition states or time steps is not uniform, as could be the case for continuous-time planning), or both. The time steps refer to the steps in a given path of a motion plan. As an example of maxSteps, if maxSteps=12, this means that the path for an agent determined by Path Finder process 200 would have at most 12 time steps. The path created for robot four 508 in FIG. 5 in third iteration grid 500c illustrates 12 time steps, which could be a result of maxSteps set to 12. In some implementations, the 12 time steps for robot four 508 may be a result of the coordinator server using the Path Finder process 200 to determine a conflict free path to the target state 524 for robot four 508 (while this is not shown at block 204 in FIG. 2, the Path Finder process 200 can be configured to include this as an exit condition when analyzing paths for an agent). MaxSteps and T are related in that if the time steps in a planning horizon have the same duration, then maxSteps*stepDuration=T. An example of time steps can be seen in FIG. 5 with agent state 526a at time step 1, agent state 526b at time step 2, and agent state 526c at time step 3. The combination of time step 1, time step 2, and time step 3 for agent 502 provide a path or motion plan to the target state 512 for robot one 502.

A planning horizon can be configured to adjust the tradeoff between solution quality and run time. A short planning horizon will enable the coordinator server using the Path Finder process 200 to generate plans in a short amount of time but with limited lookahead using fewer computational resources, while larger time horizon values can reduce the myopic nature of the plans at the expense of longer computation. In some implementations, the coordinator server configured with the Path Finder process 200 may determine the best or optimal path based on one or more metrics, including but not limited to, the minimum number of step periods needed to reach the target state and the energy consumed in reaching the target state, which provides technological improvements over prior path finder systems through increase system efficiency. It should be appreciated that in some implementations, the coordinator server configured with the Path Finder process 200 may determine a path that is less than the best or optimal, but is still suitable path for agents.

In some implementations, the planning horizon time T or maxSteps may not be long enough for agents to reach their corresponding goal by the end of the planning horizon. In some such implementations, the generated path for an agent k can be one that makes suitable progress towards the goal (i.e., target state), but where such agent k does not reach its goal. For example, in simulation experiments of a cross-dock operation with a discretized time bucket of Δ=1 sec (stepDuration), values of T of 25 to 40 sec (e.g., the planning horizons) in general resulted in incomplete paths for agents that were far enough from their goals at any given time, but were found to give an adequate trade-off between lookahead for path generation and computation time. Another example of this situation can be seen in the second iteration grid 500b for robot 1 in FIG. 5 and at block 212 of FIG. 2. In some implementations, the coordinator server running the Path Finder process 200 may find suitable paths for an agent before a stop condition in block 204 has been reached. In some such situations, the coordinator server can be configured to terminate the Path Finder process 200 before the stop conditions at block 204 have been reached, which increases the efficiency of the coordinator server because it saves processing cycles and memory usage for the coordinator server. In some implementations, the coordinator server can continue to run the Path Finder process 200 despite reaching an agent's goal (e.g., target state). For example, in the case that the coordinator server running the Path Finder system finds a path that reaches an agent's goal (e.g., target state) at some time t*<T (which is before a stop condition is reached at block 204 in FIG. 2), it can be beneficial for the coordinator server to cause the Path Finder process 200 to continue expanding the path for one or more subsequent time periods t, with t*<t≤T, for the agent so that the paths for other agents can be adjusted accordingly. In this case, a completed plan could be configured such that the agent k remains at its goal for a plurality of time periods t such that t*<t≤T. Alternatively, if an upper bound U on the time the agent k needs to spend at its target state is known, the coordinator server running the Path Finder process 200 could return a path where the agent remains at the agent's target state for at least a plurality of t in t*<t≤U.

Embedded in the Path Finder process 200 is a suitable path finding algorithm (which may include a modified A* algorithm, such as illustrated in FIG. 2) that may include a heuristic. The heuristic may comprise an inexpensive function that avoids, limits, or prevents overestimating the cost of reaching a goal from the given initial state, also known as the cost-to-go. In some implementations, the heuristic can be used for ordering states in the search queue in process 200, so that the head of the search queue (such as the search queue created at block 209 in FIG. 2) contains the state of an agent with the lowest cost achieved so far plus estimated cost-to-go. As an example, a typical implementation of this heuristic for agents that limit movement to vertical or horizontal movement corresponds to the so-called Manhattan distance, given by the sum of absolute differences in Cartesian coordinates between the two states (i.e., |xₛ−x_{g}|+|yₛ−y_{g}|, where (xₛ, yₛ) are the coordinates of the initial state s and (x_{g}, y_{g}) are the coordinates of the goal state g). In some implementations, tight heuristics can be used (e.g., heuristics with the least amount of underestimation of the cost-to-go) since this can reduce the number of nodes that need to be explored by the path finding algorithm. For example, for the case of agents (e.g., autonomous robots) that have restricted travel (e.g., non-holonomic agents that can move vertically, horizontally, and/or rotate in place), a tighter heuristic could also incorporate the minimum number (or some other suitable number) of rotations to reach the goal state. To illustrate, let (x, y, θ) denote the position and orientation of such an agent in a 2D grid. If s=(0, 0, 0) and g=(10, 10, 90), at best, the agent would travel a total of 20 distance units to get to its goal and it may perform a 90-degree counterclockwise rotation. Assuming a travel speed of 1 distance unit (e.g., one grid space in a graph S) per second and a rotation speed of 90 deg / sec, the heuristic would return a cost of 21 sec for this path.

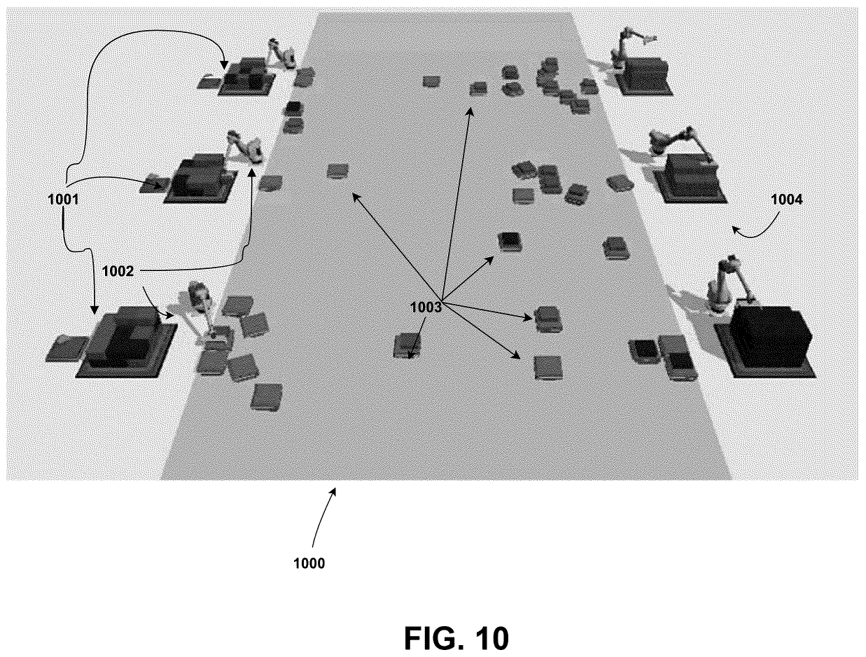

In some implementations, the Path Finder process 200 includes a maxExploredStates parameter that can limit the number of transition states that get expanded as part of the path finder search (e.g., the number of states that can be searched and potentially added to the search queue), as evaluated in block 204. The maxExploredStates refers to the number of iterations of states retrieved from the search queue. For example, after block 203, the coordinator server may increment a counter of explored states and then compare the counter of explored states against the maxExploredStates. This parameter enables early stopping of the search, which is useful for controlling the total time it takes to generate a coordination plan at the coordinator server, at the expense of solutions with lower quality. For example, in the cross-dock simulation from FIG. 10, a value of maxExploredStates=250 has been found to work well. When maxExploredStates is set to 250, this means that the Path Finder process 200 will explore at most 250 transition states (from different paths) to find a suitable path for an agent. In some implementations, the Path Finder process 200 may be configured with a GoalTolerance parameter, which can control the maximum distance to the target state (as measured by the heuristic) at which the search terminates. When GoalTolerance=0, the search can be configured to not terminate until the target state is reached (or until the coordinator server running the Path Finder process 200 determines that an optimal path will take longer than T units or the number of expanded states reaches maxExploredStates). Setting a value of GoalTolerance greater than 0 is useful in cases where it is known that the optimal target state cannot be reached, but a close-enough end state suffices for the calculation for the current planning horizon. For example, in some implementations, the target state might represent a single location where agents may perform an activity such as, e.g., receive a box, and multiple agents could be headed to the same location at the same time. In such a case, one agent may be able to reach the target state at a particular time and the GoalTolerance could be set to a positive value for the other agents.

In one implementation of the coordinator server running the Path Finder process 200, the agent's target state may not be a single vertex in S but could comprise a set of vertexes. For example, if the ending orientation of an agent is not relevant, the agent's target state could be specified through the state set {(x_{g}, y_{g}, 0), (x_{g}, y_{g}, 90), (x_{g}, y_{g}, 180), (x_{g}, y_{g}, 270)}, where (x_{g}, y_{g}) is the desired end location. In another example, the set of vertexes could consist of cells of a graph S reserved for robots queuing at a workstation, and the coordinator server could be configured to find paths to the closest queue cell available. In cases such as these, the GoalTolerance could be applied against a plurality of states in the target state set, to determine if the termination condition has been met. Similarly, the heuristic in this case could be calculated for the states in the goal set and the lowest cost returned.

In some implementations, as noted above, the coordinator server using the Path Finder process 200 has access to one or more Reservation Manager objects (RM), which keeps track of existing reservations of agents in state-space-time. The RMs may be provided in the coordinator server. The RM may be provided in a warehouse manager, as will be discussed in more detail below. When expanding a node in the path finding search, the coordinator server configured with the Path Finder process 200 may query the RM objects to determine if the expanded node would interfere with an existing reservation as discussed in connection with block 208. In some implementations, the coordinator server determines interference based on the agents'kinematics and dimensions. For example, the RM objects enable the coordinator server to determine if generated paths would cause two agents occupy the same cell in a graph S at the same time, as well as paths where two agents travel along the same edge of the graph S (in opposite directions) at the same time. Depending on the agent dimensions, the coordinator server, using the RM objects, could also preclude paths where one agent moves into the cell that was occupied by another agent at the previous time and the agents are moving orthogonally to each other.

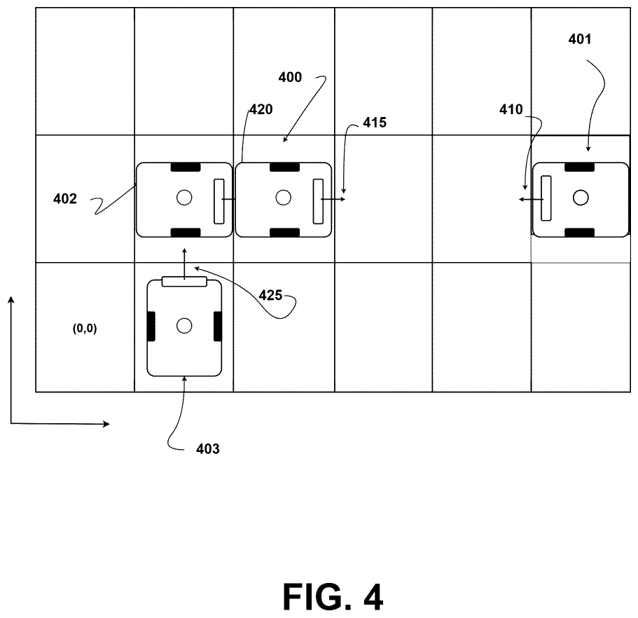

Some example agent-conflict scenarios are illustrated in FIG. 4. Agent 400 is headed right as shown with direction arrow 415 while agent 401 is headed left as shown with direction arrow 410. Assuming one cell movement per time step, as illustrated in FIG. 4, agent 400 and agent 401 can both move one cell at time step 1 in their intended respective directions, but cannot both continue their motion in the same direction without creating a conflict at time step 2. Agent 402 can tailgate and move behind agent 400 at time step 1 as shown with direction arrow 420, since they are both traveling in the same direction. However, agent 403 is not able to complete its motion as shown with direction arrow 425 at time step 1 because agent 402 will still be partially blocking cell (1, 1) at step 1 as it completes its motion to the adjacent cell. The coordinator server may determine conflicting reservations for the agents in the case in which time is treated as a continuous variable by determining if the time intervals (t₀, t₁) and (t′₀, t′₁) of two potentially conflicting state transitions have any overlap.

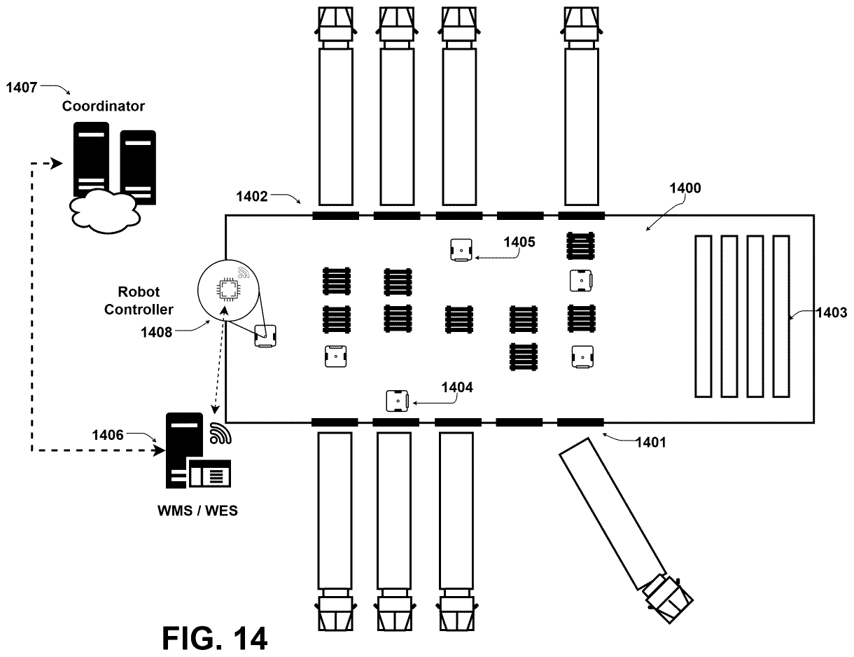

Turning to FIG. 3, in some implementations, the coordinator server may be configured with a Base Planner process 300. The Base Planner process 300 may leverage the Path Finder process 200 and is responsible for generating a set of coordinated paths for one or more agents. For the one or more agents managed by the coordinator server, the Base Planner process 300 consumes a list of the agents'current (initial or origin) states and their tasks. The coordinator server may obtain the agents'states and tasks from a warehouse server such as the warehouse server 1406 discussed in connection with FIG. 14 below. In some implementations, the coordinator server using the Base Planner process 300 may apply an iterative process for generating a set of conflict-free paths for one or more agents, illustrated in FIG. 3. Paths from one iteration can be used by the coordinator server to determine paths in a later iteration. The Base Planner process 300 may comprise of two loops, referred herein as the outer loop (with looping condition in block 302) and the inner loop (with looping condition in block 304). At block 301, prior to starting the outer loop, the Base Planner may sort agent tasks, where agents are associated with at least one task comprising an origin and a target state. This sorting can be performed based on one or more criteria, which may include attributes about the task (e.g., priority, estimated distance to the target state, etc.) and the agent. A task definition may include the allocated agent and its target state (e.g., destination). It may also include other information relevant for the task assignment, including a priority value. Sorting of the agent tasks can be used to, e.g., ensure that the paths generated for agents with high-priority tasks take more efficient routes and are completed earlier than agents with lower-priority tasks. Furthermore, for breaking ties between equal-priority tasks, one of several criteria could be applied, including random sorting and sorting by distance to the goal in either ascending or descending order, etc. Random sorting is useful in implementations where it is possible for the coordinator server to run multiple replications of the Base Planner process 300 and keep the results with performance according to some predefined metric (e.g., the sum-of-costs metric). Sorting by agents'tasks by distance in ascending order can be useful in cases where multiple agents are headed to the same goal and there is no precedence requirement for agents. In such a case, the time before an agent reaches its target state will tend to be minimized. In some implementations, it can be beneficial for the coordinator server to re-sort or shuffle the agents'tasks on one or more subsequent iterations of the outer loop in the Base Planner process 300. In such cases, the coordinator server's sort task procedure may be executed at block 303.

In some implementations, the coordinator server (such as coordinator server 1505), using the Base Planner process 300 as shown at block 301, may initialize a pair of RM objects. An RM object may hold a map of reserved states by agent and time interval and may allow for efficient look-up of existing agent reservations at a given location and overlapping with a given time step or time interval. In some implementations, the coordinator server may store several RM instances for the Base Planner process 300 In some implementations, the coordinator server using the Base Planner process 300 utilizes a working RM object (workingRM) and a reference RM object (refRM), and both start empty. The workingRM object may be populated with agent reservations made during the current iteration of the outer loop of the Base Planner process 300 while the refRM object may hold reservations made during the previous iteration of the outer loop of the Base Planner process 300. In some implementations as shown at block 301, the coordinator server may also initialize an outer iteration counter i. In some implementations, the outer iteration counter i can be set to zero at the point of initialization.

After initialization, the coordinator server proceeds iteratively to find paths for one or more agents. In some implementations, this may include minimizing agent collisions and agent congestion for a plurality of agents (e.g., an automated warehouse setting with 200 or more robots). In some implementations, as shown at block 302 the coordinator server determines with Base Planner process 300 if it should stop or move to the next block. If the coordinator server determines that no conflicts were found in the working RM or if the maximum number of iterations (MaxIt) has been reached, the Base Planner process 300 may stop and return the reservations in the working RM as shown at block 307. Otherwise, the coordinator server moves to the next block 303 in the outer loop. In some implementations, the Base Planner process 300 at block 302 may determine decide to continue iterating even if there are no remaining conflicts (but the MaxIt has not been reached) if the coordinator server it determines that the paths for one or more agents can be improved. An example of an improvement is the coordinator server determining that a path for an agent to reach its target state can be shortened. Another example of an improvement is the coordinator server determining that different paths for multiple agents would result in less energy being consumed by the agents in reaching their respective target states.

Considering iterations from the outer loop, at block 303 of FIG. 3, the coordinator server may clear the refRM, which corresponds to erasing from its memory one or more agent reservations, transferring or copying agent reservations from the workingRM into the refRM, and clearing agent reservations from the workingRM. The coordinator server may also set an inner iteration index k=0 so that the coordinator server knows when to stop computing agent paths as part of the inner loop of the Base Planner process 300. The coordinator server running the Base Planner process 300 may perform an inner loop that iterates over agent tasks in sorted order starting at block 304. The coordinator server may determine if inner iteration index k has reached a predetermined number of agent tasks as shown at block 304. As shown at block 305, for a particular agent and associated task in this inner loop iteration of Base Planner process 300, the coordinator server clears the refRM agent reservations for that agent and calls or otherwise initiates execution of a path finder system. In some implementations, coordinator server uses the Path Finder process 200 of FIG. 2 (or some other suitable path finder process) to find a path that respects reservations from both RM instances. In some implementations, this causes the path generated by the coordinator server using a path finder system to respect (if possible) agent reservations from the workingRM for agents that have already been planned in the current inner iteration, and agent reservations from the refRM for other agents that have not yet been assigned plans in the current inner iteration. Further, by clearing the refRM reservations for agents that have been processed and provided new paths in the workingRM, this improves the performance of the coordinator server. That is, by clearing the reservations for agents stored in refRM as such agents are processed in the Base Planner process 300, this reduces the reservations that the coordinator server analyzes in the refRM as part of the Path Finder process 200 at block 208. Thus, the coordinator server is made more efficient by limiting the processing cycles and memory usage that would otherwise be used to analyze uncleared and extra reservation paths in the refRM.

Even though the Path Finder system can determine the path for a given agent with knowledge of the intended paths of one or more other agents, in some implementations it may still not be possible to find a conflict-free path for a given agent on a given iteration (e.g., a feasible path that avoids an incoming collision with another agent is not available for an inner iteration of the Base Planner process 300). As also shown at block 305, the coordinator server may add the agent's path reservations to workingRM. In some implementations, the coordinator server receives a path from the Path Finder process 200 and an indicator associated with the path. For example, as discussed at block 211 of FIG. 2, one possible indicator is that the path for the agent was determined to be optimal. As another example, as discussed at block 212 of FIG. 2, one possible indicator is that the path for the agent was determined to be incomplete. In yet another example, as discussed at block 210 of FIG. 2, one possible indicator is that the path for the agent was undetermined or determined to be infeasible.

In some implementations, to reduce the coordinator server's running time of Base Planner process 300, once a conflict-free path for one or more agents has been found, it may be desirable to avoid recomputing such paths in subsequent (outer) iterations of the process. A MaxFullReplanIterations parameter can be used with the Base Planner process 300 to configure the coordinator server to limit how many iterations the Base Planner process 300 may run through with replanning paths of one or more (or all) agents before focusing on path replanning for agents that still have conflicts in their generated paths. When an agent is skipped from path replanning, the agent's path from the refRM can be copied to the workingRM. In some implementations, when a new plan for an agent is conflict-free, the agent can be removed from a set defining agents with generated paths having conflicts. In some implementation, the coordinator server can check if the MaxFullReplanIterations has been reached between block 304 and block 305. For example, MaxFullReplanIterations can be compared against the value of i (iterations as tracked in block 306). If MaxFullReplanIterations have not been reached, the coordinator server will recompute paths for available agents. If MaxFullReplanIterations have been reached, the coordinator server will recompute paths for agents that have path conflicts. In some implementations, if agent has a conflict that cannot be avoided, the path is infeasible for an agent. Infeasible paths can be recomputed in iterations before MaxFullReplanIterations and after MaxFullReplanIterations. In some implementations, the coordinator server does not recompute optimal or incomplete paths (which are conflict-free) beyond MaxFullReplanIterations.

It should be appreciated that there are alternative implementations of the process discussed above that may reduce computational run time without altering functionality of the process. For example, instead of copying the workingRM reservations to the refRM at the beginning of an outer iteration of Base Planner process 300, memory pointers to the workingRM and refRM stored in memory (e.g., whether in the cache or RAM of the coordinator server, or some other suitable memory storage for the route planning system) can be swapped. To illustrate with an example, if an RM holds reservations for 1000 agents over 100 discretized time steps and individual reservations are represented as a tuple of 4 integers (time step, x-axis coordinate, y-axis coordinated, and orientation) in physical memory, the RM will consume 1.5 MB of memory (assuming each integer requires 4 bytes of memory). Copying this amount of memory from a RAM storage device with a data throughput of 19 GB/s would consume 0.08 msec of time. By swapping addresses instead, the coordinator server can be made more efficient by reducing the amount of memory to 8 bytes for memory locations that are copied.

FIG. 5 is an example illustration of the coordinator sever using the Base Planner process 300, the Path Finder process 200, and the benefits of the iterative nature of the processes for the case of four robot agents operating on a 2D grid (e.g., a graph S). In particular, FIG. 5 illustrates an example of the paths that can be generated by the coordinator server over different iterations of the Base Planner process 300 according to some implementations of the present disclosure. The FIG. 5 shows three sets of grid representations in columns labeled first iteration 501a, second iteration 501b, and third iteration 501c. The column of grids in one iteration depict the same operational environment for the robots at different stages of the iterative path finding process (outer iterations of Base Planner process 300). The vertical column of grids in an iteration correspond to the same physical grid, but are illustrated as separate grids to better show the paths that can be created for the individual robot agents on the inner loop iterations starting at block 304 of Base Planner process 300. The column of grids in an iteration show the possible planned paths for a single grid for robot one 502, robot two 504, robot three 506, and robot four 508 as they navigate from their respective initial states/positions to their target states/positions.

In some implementations, agent tasks (which include, among other things, where an agent's target state is located in a grid) can be are prioritized by an agent index (e.g., robot 1 takes priority over robot 2, robot 2 takes priority over robot 3, and robot 3 take priority over robot 4 and so on). The initial locations/states of the robots are denoted in the grids, as are the robots'the target locations/states. In first iteration 501a, robot one 502 has a target state 512, robot two 504 has a target state 516, robot three 506 has a target state 520, and robot four 508 has a target state 524. The numbered blocks in a grid indicate the time step at which a robot is expected to reach the corresponding cell based on the planned path. In iteration one, robot one 502 is shown with a path generated by the coordinator server that reaches target state 512 (e.g., location) after three time steps. The path for robot one 502 is indicated by numbered cells (cell 1, cell 2, and cell 3) showing the progression of planned movement of robot one 502. The cell 1 for robot one corresponds to robot one's state 526a at time step 1. The cell 2 for robot one corresponds to robot one's state 526b at time step 2. The cell 3 for robot one corresponds to robot one's state 526c at time step 3, which also happens to be the target state of robot one. Similarly, the path for robot two 504 is indicated by numbered cells (cell 1, cell 2, and cell 3) showing the progression of movement of robot two 504. The cell 1 for robot two 504 corresponds to robot two's state 528a at time step 1. The cell 2 for robot two 504 corresponds to robot two's state 528b at time step 2. The cell 3 for robot two corresponds to robot two's state 528c at time step 3, which also happens to be the target state of robot two 504. During the first iteration, the coordinator server is unable to find paths for robot three 506 due to potential conflicts with robot two 504. Specifically, the coordinator server is not able to find a feasible path for robot three 506 because it would take more than two time steps for robot 3 to rotate and avoid a collision with robot 2 based on the path reservations created for robot two 504. Similarly, the coordinator server is unable to find complete feasible paths for robot four 508 due to potential conflicts with the path reservations assigned to robot one 502.

As noted in block 302 of FIG. 3, the coordinator server may run another iteration of Base Planner process 300 if the reserved paths for the robots are not conflict free or the maximum number of iterations has not been met. As shown in the second iteration 501b, the coordinator server refined the reservations paths shown in the second iteration grid 500b. The coordinator server refined the reservations based on the reservation information from the previous iteration. That is, during the second iteration of Base Planner process 300, the coordinator server analyzed the agent path reservations computed during the first iteration 501a (e.g., stored in the refRM) to determine new path reservations for robot one 502, robot two 504, robot three 506, and robot four 508. The stored reservation in the refRM can help inform the coordinator server when developing new paths for higher-priority robot one 502 and robot two 504. As shown in second iteration 501b, the coordinator server determined complete paths for robot two 504, robot three 506, and robot four 508 that reached their respective target states and are conflict-free. The coordinator server determined a path at time step 1, time step 3, time step 5, time step 6, and time step 8 for robot two 504. In some implementations, a robot uses one or more time steps to change headings. In the illustration, the robot two 504 used time steps 2, 4, and 7 to rotate to change direction, so these time steps are not shown because these time steps are where the robot two 504 remained in the same cell of the grid. The coordinator server determined a path at time step 4, time step 5, and time step 6 for robot three 506. This indicates that the robot three 506 was directed to wait to move until time step 4, which allowed robot two 504 to maneuver out of the straight path of robot three 506. The coordinator server determined a path at time step 5, time step 7, time step 8, time step 10, and time step 12 for robot four 508. Robot four 508 rotated to change heading at some during time steps 1-4 and waited to move until time step 5 to allow robot three 506 to move from its origin state at time step 4. Robot four 508 used time step 6 to rotate to a new heading before moving to the locations for time step 7 and time step 8. Robot four 508 used time step 9 to rotate to a new heading, but moved to its position at time step 10. Similarly, robot four 508 used time step 11 to again rotate to a new heading before moving to its target state at time step 12. In this example, an incomplete path for robot one 502 is found during this second iteration 501b, even though robot one 502 was assigned priority over the other robots. The incomplete path for robot one 502 is a result of the planning process examining the refRM. The refRM contained reservations of the origin states for the robots for the prior planning horizon. For example, when the coordinator server examined the path to the target state 512 for robot one 502 from refRM in the second iteration 501b, it found no conflict to move forward one grid segment for time step one, but determined that robot 4 508 reserved its current grid segment (3,2), which could have been the next state for robot one 502 in time step 2, creating a path conflict. Thus, even though the task for robot 1 502 was assigned the highest priority, the reservations in the refRM for the other robots imply that a clear path is not available for robot one 502 to reach its target state 512 and coordinator server thus moves robot one 502 as close as possible to its target state 512 (and could flag the path as incomplete as discussed in connection with block 212 in FIG. 2). While the other robots in the second iteration 501b are shown developing paths to their target state and appear to provide a clear path for robot one 502, the paths for robot two 504, robot three 506, and robot four 508 were determined after the path for robot one was computed for the second iteration 501b.

As noted in block 302 of FIG. 3, the coordinator server may run another iteration of Base Planner process 300 if the paths are not conflict free or the maximum number of iterations has not been met. As shown in the third iteration 501c, the coordinator server refined the path reservations shown in the third iteration grid 500c. In third iteration 501c, the final iteration of this example provided complete paths for the four robots as shown in third iteration grid 500c. The refRM contained complete paths for robot two 504, robot three 506, and robot four 508 from second iteration 501b, which enables the coordinator server to determine a complete path for robot one 502. As with iteration 1 and iteration 2, the numbered cells in the third iteration grids 500c indicate the time steps at which a robot is expected to reach the indicated cell based on the planned path. Contiguous number gaps between numbered cells indicates that the robot was to wait and/or change heading. It should be appreciated how the iterative Base Planner process 300 progressively resolves conflicts and generates coordinated motion paths for agents in the system. In contrast, a traditional planning system that plans for each robot in sequence, but that does not iterate and use a refRM in subsequent iterations would have resulted in infeasible plans for robot three 506 and robot four 508 in subsequent iterations without manual intervention.

In some implementations, to increase the chances of rapidly finding a collision-free set of reservations, it can be helpful to initialize the refRM with reservations that block the initial locations of one or more agents for a specified number of time periods. In some implementations, this can be controlled in the coordinator server by using an InitialConflictMaxWait parameter. If, e.g., InitialConflictMaxWait=4, a cell occupied by an agent for which a plan has not been yet generated during the first iteration by the coordinator server, will appear as blocked for the first 4 time steps during the first outer iteration of Base Planner process 300. This helps prevent the generation of paths for other agents that move straight into an agent without giving such agent enough time to dodge the incoming collision (considering that such agent might have to first change its orientation before it can move away).

In some implementations, it may be desirable to freeze a portion of a path for one or more agents when the coordinator server is computing a coordinated plan. This frozen path segment could correspond to, e.g., travel commands that have been already provided to a path execution system and are expected to be completed by the time a new plan is generated. Freezing path segments can also be useful to quickly recompute paths for a subset of agents. For example, in a warehouse setting where an agent might suddenly become available after waiting at a workstation, it may be desirable to quickly compute a path for that agent to depart from the workstation and for any queueing agents to transition into the workstation.

In some implementations, larger scale agent operations can be handled using the concepts discussed above with some changes and additions. For example, industrial applications such as, e.g., AMR systems for warehouse automation, can deploy several hundred agents or more operating together. Using techniques described below, route planning and coordination systems can be configured to scale to larger fleets of agents without significantly increasing computation time of system equipment, such as a coordinator server. To achieve this scalability, object composition and concurrency can be leveraged. A coordinator server can be configured to utilize one or more Base Planner processes, wherein the coordinator server can synchronize output from a plurality of Base Planner processes using a concurrent RM, for achieving this scalability.

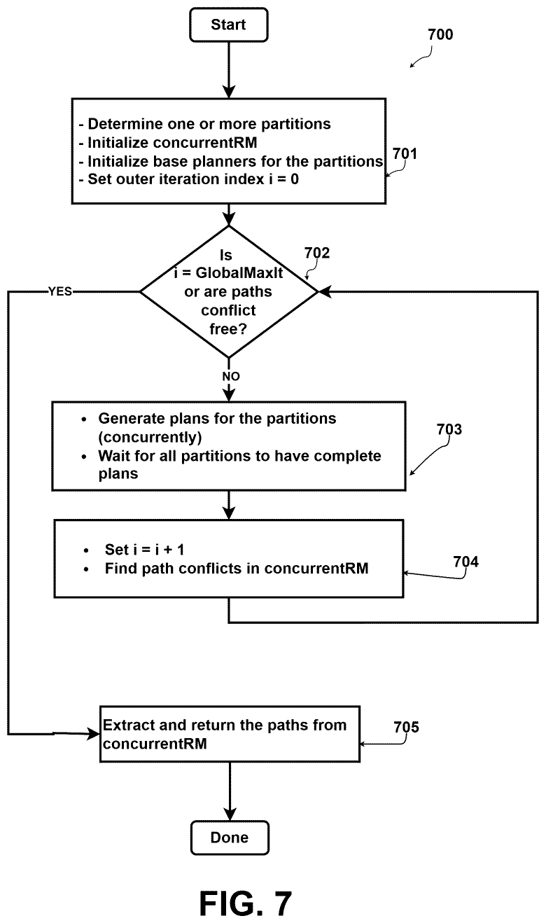

In some implementations, a coordinator server (e.g., coordinator server 1505) uses a distributed planner process 700 of FIG. 7 to break down route reservation planning into smaller segments for analysis. In some implementations, the distributed planner process 700 enables a coordinator server to partition an operating environment for agents according to some criteria that aims to keep agents that are likely to generate conflicts among other agents within a same partition. One partition scheme may include partitioning an environment grid into K connected sub-graphs. In some implementations, the plans for these partitions can be computed in parallel by different processing units, thereby reducing the number of tasks that the units process and thus shortens the time to generate a complete plan for a planning horizon.

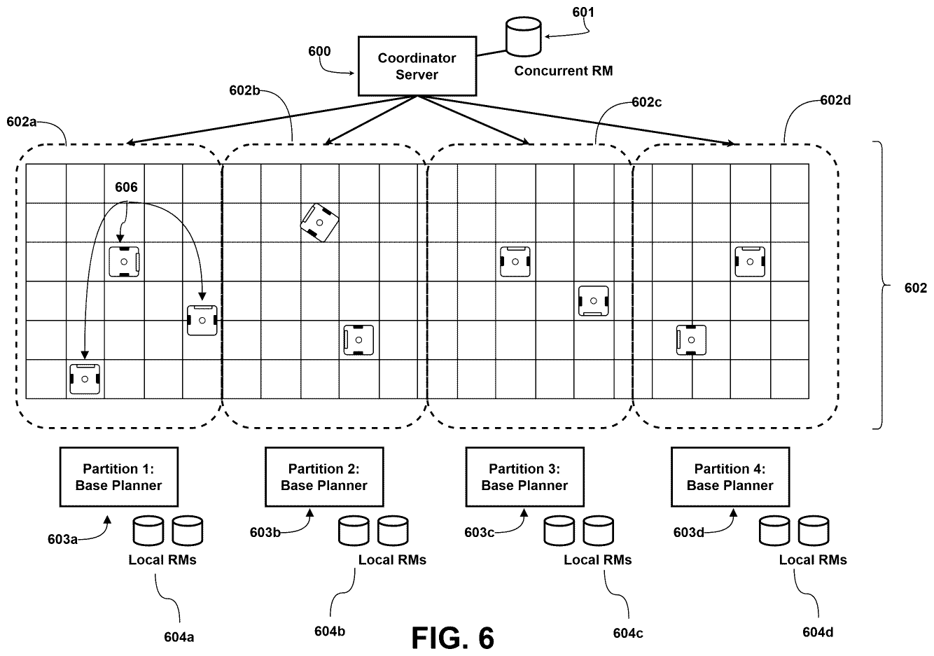

FIG. 6 illustrates an example of distributed planning for many agents across a large planning area according to some implementations of the present disclosure. The figure shows a coordinator server 600 (e.g., coordinator server 1505) that manages a rectangular grid 602 partitioned into four distinct sub-grids indicated by dotted boundary lines: partition 1 602a, partition 2 602b, partition 3 602c, and partition 4 602d. Multiple agents 606 are distributed throughout the grid 602 and are positioned at various locations within the different partitions.

The coordinator server 600 may include a concurrent reservation manager 601, which serves as a shared resource for coordinating reservations across one or more partitions. Coordinator server 600 may use multiple base planner instances. In some implementations, individual partitions are associated with dedicated base planner instances to operate with individual partitions. For example, partition 1 base planner 603a manages agent reservations for partition 1 602a, partition 2 base planner 603b manages agent reservations for partition 2 602b, partition 3 base planner 603c manages agent reservations for partition 3 602c, and partition 4 base planner 603d manages agent reservations for partition 4 602d. These base planner instances may operate concurrently to generate motion path reservations for agents within their respective partitions.

The coordinator server may maintain separate local reservation managers objects (localRMs) associated with individual partition base planners and partitions. The localRMs are used for tracking agent reservations within an associated partition. For example, partition 1 602a is associated with local reservation manager 604a, partition 2 602b is associated with local reservation manager 604b, partition 3 602c is associated with local reservation manager 604c, and partition 4 602d is associated with local reservation manager 604d. The localRMs may store, among other things, agent state and time step information for agents operating within their corresponding partitions. The localRMs may store any information that were stored in connection with other RMs discussed herein. LocalRMs may store any other suitable information used by a coordinator server to perform route planning. As will be described below, the data stored in the localRMs can also be stored in the concurrent reservation manager 601 to create a central clearinghouse for data from multiple localRMs, to enable the coordinator server to analyze path conflicts between localRM data in a centralized location. It should be appreciated that in some implementations, the coordinator server does not need to use a concurrent reservation manager 601 to store duplicate data from the localRMs. For example, the coordinator server can obtain data from one or more localRMs when analyzing such data for path conflicts.

The distributed architecture enables the system to scale to larger fleets of agents by parallelizing the agent route planning and reservation computations across multiple partitions of an operating area grid. The base planner instances may access both their local reservation managers and the concurrent reservation manager 601 to help ensure conflict-free path generation while maintaining coordination across the agent operational area. The coordinator server 600 also communicates with the various partition base planners, enabling coordination of agent movements across virtual partition boundaries when agents transition between different partition zones of the grid 602.

In some implementations, other partitioning schemes could be used such as ones based on the agents'starting or ending locations using, e.g., a clustering algorithm such as K-means clustering. In some implementations, functions of the partition base planner instances and local RMs are contained within one coordinator server. It can be the same coordinator server executing the distributed planner process 700 or one or more other coordinator servers. In some implementations, individual partition base planners and localRMs may be executed by different coordinator servers. In some implementations, some partition base planners and localRMs may be grouped together and executed by one coordinator server while other partition base planners and localRMs are grouped together and executed by one or more different coordinator servers.

Returning to FIG. 7, in some implementations, the distributed planner process 700 begins at block 701. A coordinator server may determine one or more partitions for an operating area such as grid 602. In some implementations, the coordinator server can partition the grid by dividing the grid into substantially equal parts. This method can be suitable when the agent distribution across an operating area is relatively balanced. In some situations, the agent distribution is not well balanced and agents might be concentrated in one or more segments of the operating area. In such a situation, the coordinator server may determine to partition a grid for an operating area in a manner that breaks the agents in the operating area into smaller groups. In some such situations, the partition decision may be based on where agent tasks are concentrated so that an individual based planner is not overloaded with agent route reservation processing. In some implementations, the partitioning could be static or change dynamically during one or more subsequent iterations of the distributed planner process 700 (and current base planner processes 800). If coordinator server is configured to dynamically change the partitions, the process to determine partition may also be included in both block 701 and block 703 or executed in block 703 without performing partitioning in block 701. As also shown in block 701, the coordinator server may initialize a concurrent RM instance that can be shared among one or more individual partition base planners such as partition 1 base planner 603a, partition 2 base planner 603b, partition 3 base planner 603c, and partition 4 base planner 603d. In some implementations, the coordinator server initializes one or more base planners and associated localRMs. The coordinator server may initialize individual base planners to be associated with a particular partition of the determined partitions. The coordinator server may initialize an iteration counter and set the iteration counter to zero.

In some implementations, as part of the route planning for agents, the coordinator server may execute different partitions and cause agent tasks to be processed in a concurrent fashion during one or more iterations of distributed planner process 700. As shown in FIG. 7, after the initialization steps, the coordinator server may determine evaluate one or more stop conditions for the distributed planner process 700. In some implementations, coordinator server can check if a maximum number of iterations have occurred. The coordinator server may check if the determined paths for the agents are conflict free. In some implementations, iterations of the distributed planner process 700 can start at block 703 after block 701 and the loop control flow condition is evaluated in block 702 after route reservation plans have been initially determined.

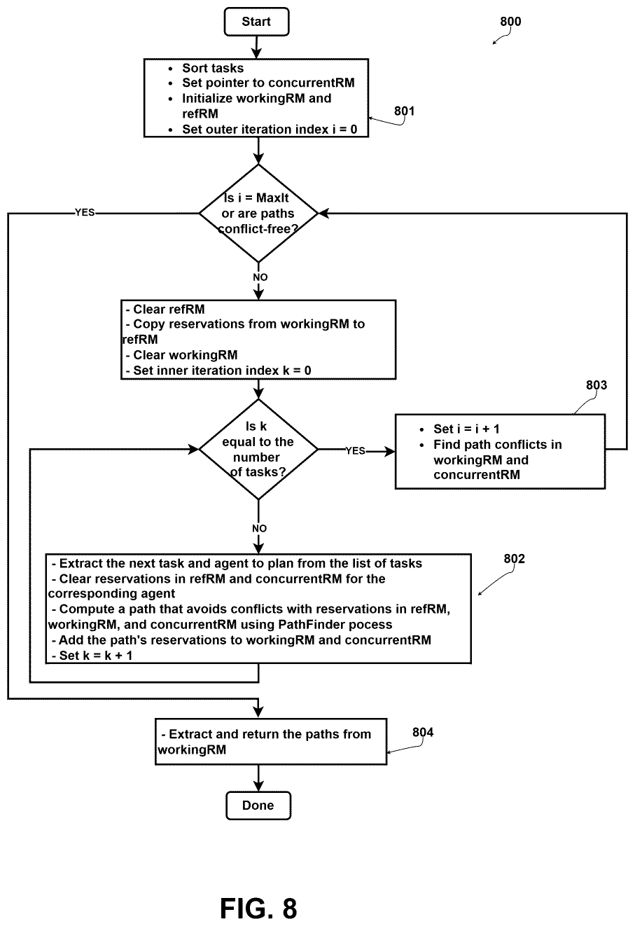

In some implementations, at shown at block 703, the one or more coordinator servers concurrently run the partition base planner instances that were created in block 701. An example partition base planner process that a coordinator server can use to determine path reservations for agents is discussed in connection with FIG. 8 below. The partition base planner instances may run for agents in its corresponding partition until a stop condition is met. In some implementations, the coordinator server may wait for one or more partitions to complete their planning before incrementing the iteration counter as shown at block 704. In some implementations, as also shown in block 704, the coordinator server may compare path reservations received from the various partition base planners to find if conflicts might exist across one or more path reservations from individual partition base planners. For example, coordinator server may compare agent path reservations in local RMs against agent path reservations stored in the concurrent RM. If at the end of an iteration no conflict has been found, or if the maximum number of iterations have been reached at block 702, the distributed planner process 700 may conclude, and the global reservations are returned at block 705 as the output of distributed planner process 700. Otherwise, the coordinator server may continue the distributed planner process 700 and start the next iteration at block 703. In some implementations, the coordinator server may re-plan agents that had conflicts in previous iterations (after some maximum number of full-replan iterations). In some implementations, the concurrent RM can also be initialized with reservations blocking the starting position of one or more agents, in a similar fashion to the Base Planner.

FIG. 8 illustrates some implementations of a modified version of a base planner process discussed in connection with FIG. 3. To minimize repetition with FIG. 3, the discussion of FIG. 8 focuses on processes that differ from processes in FIG. 3. As shown in FIG. 8, one difference is that the coordinator server uses a concurrent RM in addition to a workingRM and a refRM. As shown in block 801, the coordinator server may initialize a concurrentRM and set a memory pointer to the initialized concurrentRM. This concurrentRM provides an additional set of reservations for pathfinding and conflict-resolution for the coordinator server to analyze during the concurrent base planner process 800 and also during the pathfinding process used by concurrent base planner process 800. The coordinator server uses a concurrentRM because the path reservations stored in the workingRM and refRM for a particular partition are limited to the agents in such partition. It is beneficial for the coordinator server to have data on path reservations for agents of other partitions because agents may cross between partitions to complete a task. When the coordinator server computes a new path for an agent in a partition and updates its workingRM associated with the partition, coordinator server may also update the concurrentRM as shown in block 802. The reservations in the concurrentRM may also be passed to a pathfinding process (e.g., Path Finder process 200 or some other suitable pathfinding process) to ensure that the paths determined for agents in a partition respect path reservations for agents made for other partitions. Thus, using the concurrentRM data, other partition base planner processes are enabled to plan around the latest working path of known agents from other partitions. Furthermore, when the coordinator server evaluates conflicts at the end of an iteration of the base planner process 800 as shown at block 803, reservations in both the local workingRM and the concurrentRM can be considered for determining if there are still conflicts to resolve. As shown at block 804, the coordinator server may extract and return the paths in the workingRM as a motion plan, which can be sent directly or indirectly to agents to direct agent motion. It should be appreciated that coordinator server may concurrently run one or more base planner processes 800 for an operating area that has been divided into partitions.

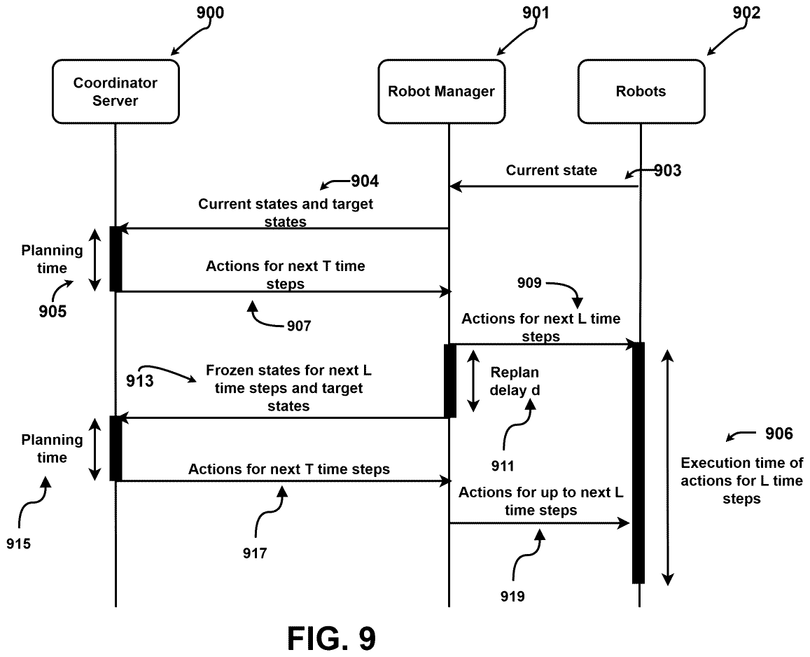

The communications in the coordination planning systems and methods disclosed here can be implemented in an asynchronous fashion to hide computation and data-transfer latencies from the agents. FIG. 9 illustrates an implementation of such an asynchronous communication scheme, within the context of an AMR system where agents corresponds to an autonomous robot. Coordinator server 900 (e.g., coordinator server 1505) is responsible for executing the coordination planning logic disclosed above (e.g., Path Finder process 200, Base Planner process 300, distributed planner process 700, concurrent base planner process 800, etc.). Robot Manager 901 acts as a lower-level communication layer between the coordinator server 900 and one or more Robots 902. In some implementations, a warehouse server 1406 (discussed below) may be configured to run Robot Manager 901. In some implementations, coordinator server 900 can be configured to run the Robot Manager 901. The Robot Manager 901 can keep track of states of Robots 902 and send a planning request 904 to the coordinator server 900 at one or more review periods t. In some implementations, this planning request 904 comprises the current states of Robots 902 and their target end states. The coordinator server 900 computes a motion plan (planned paths) for the next T time steps at 905 and returns the results to the Robot Manager as shown at 907. The Robot Manager 901 may communicate the movement actions of the motion plan to perform to one or more the Robots 902 for the next L time steps, where L≤T as shown at 909. While Robots 902 executes actions for the next L time steps as shown at 906, Robot Manager 901 may institute a robot path replanning delay d as shown at 911. In some implementations, such a replanning delay d may help avoid overwhelming coordinator server 900 with path requests while giving sufficient time for Robots 902 to execute at least a portion of their paths. Robot Manager 901 may send at a later time, another planning request to the coordinator server 900, asking the coordinator server 900 to freeze the states of Robots 902 in the next L time steps that have been or are about to get to their respective target states. If the planning time 915 of the coordinator server 900 is shorter than the time it takes the Robots 902 to execute the provided actions from 909 in the next L time steps as shown at 906, in some implementations, the coordinator server 900 can determine a next set of actions as shown at 917 (e.g., a new motion plan) for the Robots 902 before the Robots 902 complete their current batch of movement actions to new states. This enables the coordinator server to minimize latency or delays in providing Robots 902 with their next movement actions. As shown at 919, Robot Manager 901 may send the next actions for up to the next L time steps to Robots 902 before such Robots 902 have completed their existing motion actions. Sending the next actions for up to the next L time steps to Robots 902 before such Robots 902 have completed their existing motion actions is also beneficial in situations where coordinator server 900 developed a motion plan for the Robots 902 (e.g., using Base Planner process 300 and/or Path Finder process 200) that included conflicting paths. A motion plan 907 may include path conflicts between two or more robots near the end of the T time steps. For example, for a 40 time step horizon motion plan created at 907, the first 39 time steps may have been determined without robot path conflicts, but a conflict was generated at time step 40 for at least two robots. By providing a new motion plan 917 to Robots 902 before the end of T time steps in the motion plan of 907, Robots 902 can avoid collisions from the previously computed conflicting paths.

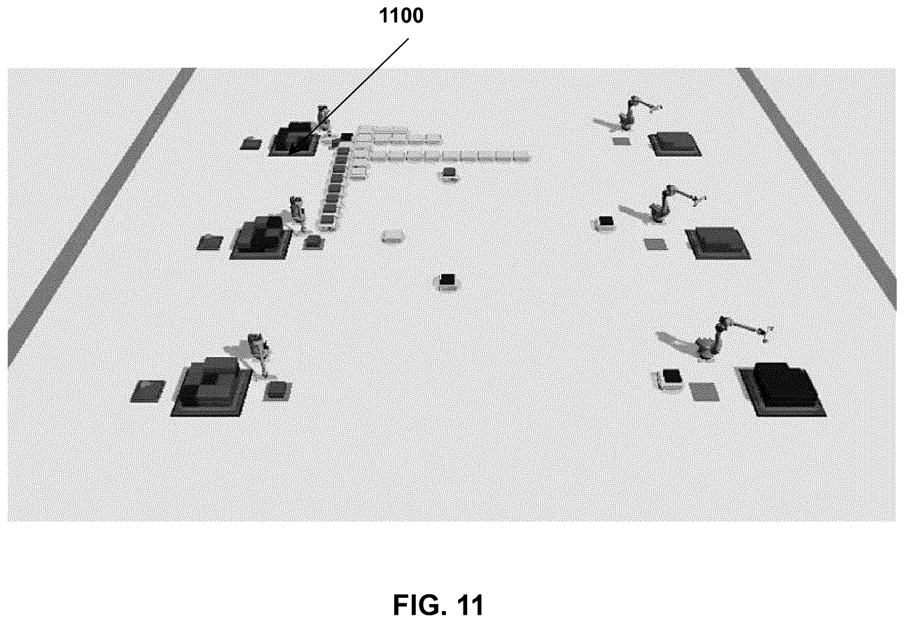

The coordination planning systems and methods disclosed herein enable new designs of multi-agent systems. Without limiting the scope of the disclosure, FIG. 10 shows an illustrative example of such a multi-agent system comprising a dense, AMR sort-center or cross-dock warehouse, where agents 1003 operate on a rectangular grid 1000 (e.g., AMR operating area) and can be constrained to in-place rotation and forward motion. In this design, incoming packages arrive on the left side of the building (receiving docks) 1001 and are loaded into an AMR using a robotic arm 1002 or other mechanism. Packages are then sorted by their destination and the AMRs 1003 takes the packages their appropriate outbound queue on the right side of the building (shipping docks) 1004. The design presented here generates a large amount of AMR cross-traffic. Traditional planning systems would require manual crafting of AMR travel patterns on the grid to avoid gridlocks of AMRs. To illustrate a gridlock situation, FIG. 11 shows a snapshot of a discrete-event simulation of the same system shown in FIG. 10, but running using a standard AMR planning system with no proactive coordination or travel patterns enforced, based on the independent planning approaches explained in the Background. As shown in FIG. 11, a gridlock 1100 of AMRs quickly forms at one of the stations, creating a total collapse of AMR motion. This creates delays and decreases system efficiency. Manual intervention would be required to unclog the AMR gridlock 1100 shown in FIG. 11. With the improved coordination planning systems and methods disclosed here, the simulated cross-dock warehouse as shown in FIG. 10 can operate smoothly without gridlocks to move AMRs and their respective packages to their intended target locations.

For the cross-dock warehouse illustrated in FIG. 10, with up to 40 agents, an implementation of the route planning coordination system disclosed here using a high-performance, compiled language can generate plans with up to 40 seconds of lookahead (e.g., a planning horizon) (i.e., T=40) in under 3 seconds. With AMR 1003 agents moving at a linear velocity of 1 m/sec and rotating in place at an angular velocity of 90 deg /sec, the simulation ran in real-time with asynchronous calls to the coordinator server (e.g., coordinator server 1505) to generate motion actions for the next 4 seconds (i.e., L=4). The coordinator server system was hosted using a RESTful API for delivering agent motion plans and receiving AMR agent states, creating a minimally invasive interface layer between the motion planning and the rest of the warehouse execution system.

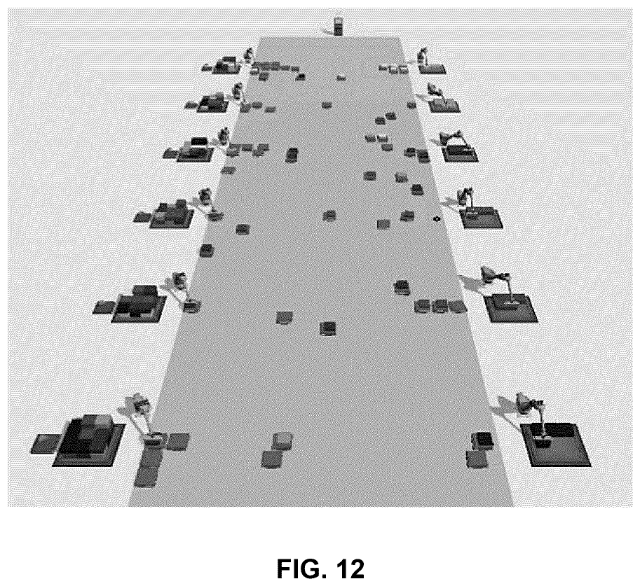

To illustrate the scalability of the concurrent base planner process 800 disclosed above, an enlarged version of the cross-dock design is illustrated in FIG. 12. In this version of an AMR system design, 4 uniform partitions of the floor (e.g., operating area) have been made (along the floor's long dimension) and a multi-threaded implementation of the concurrent base planner process 800 with 4 CPUs has been used to generate AMR agent motion plans in real-time, using the same settings as for the single Base Planner simulation shown in FIG. 10.

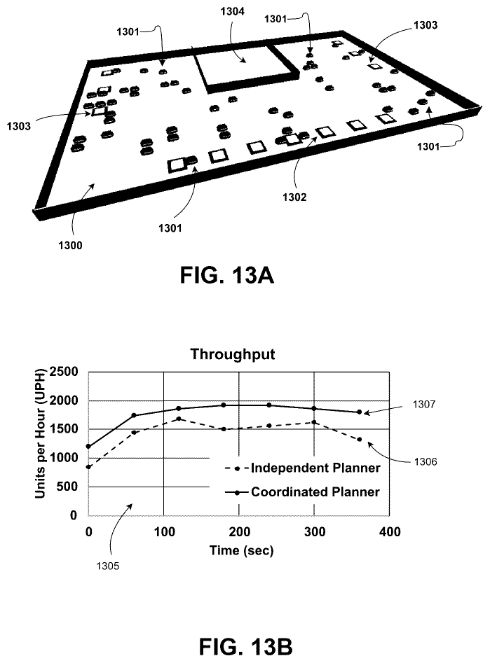

FIG. 13A illustrates a simulation model of a sortation center 1300 with 50 AMRs 1301, 7 item receiving points 1302, and 3 item sortation points 1303 on the sides of the building. The building is split into two sections by out-of-bounds area 1304, leading to an increase in congestion on the lower half of the floor. The performance of improved coordination planning systems and methods on the design of this sortation center 1300 can be compared to a standard or traditional AMR planning system (discussed in the Background) by measuring the throughput or sorted package units per hour, as shown in graph 1305 in FIG. 13B. Lower curve 1306 shows the performance of this sortation center 1300 when operated using a traditional, independent planner as the ones described in the Background. Upper curve 1307 shows the performance of the sortation center 1300 when operated using the coordination system disclosed here, where it is seen that coordination boosts performance by up to 20% over the traditional independent planner.

FIG. 14 illustrates an example of a physical implementation of the coordination planning system according to some implementations. The warehouse 1400 receives pallets on the bottom side 1401 (receiving docks) and sorts and ships pallets on the upper side 1402 (shipping docks). Storage racks 1403 for longer-term storage are located on the right side of the building. Pallet 1404 has been inducted into the system and autonomous mobile robot 1405 is available to retrieve it and move this pallet to its intended destination dock. A warehouse server 1406 can include one or more management systems. The management systems may include a warehouse management system (WMS) and a warehouse execution system (WES) (which may contain a robot manager function). The WMS can be responsible for functions such as inventory management and order fulfillment. The WES can be responsible for functions such as real-time work allocation, resource orchestration, and device integration. The warehouse server 1406 can be hosted on a computer system that may reside on the premises. These management systems of the warehouse server 1406 are responsible for the operation of the warehouse and generate the tasks for transporting inventory from the shipping docks to the receiving docks and to the longer-term storage area. The warehouse server 1406 systems may communicate wirelessly with a micro-controller 1408 embedded in the robot on the floor of warehouse 1400, to retrieve their latest position and orientation and to issue motion commands. The robot micro-controller 1408 is responsible for executing these commands in a safe and reliable manner (by, e.g., incorporating readings from local sensors to avoid collisions with debris or by adjusting motor torques to account for variations in robot load). In this example, the Coordinator server system disclosed here is implemented as cloud service 1407, hosted on a network of computer servers that can process requests made by the warehouse server 1406 systems and generate motion plans by executing one or more of the blocks described in processes described herein.

In some implementations, the coordinator server and/or the warehouse server may comprise one or more processors, memory storage devices, and communication interfaces configured to execute the coordination algorithms disclosed herein. These servers may be implemented using various computing architectures including single-core processors, multi-core processors, distributed computing systems, cloud-based servers, or dedicated hardware systems. The memory storage devices may include volatile memory such as RAM, non-volatile memory such as flash storage, hard disk drives, solid-state drives, or other suitable data storage media for storing, among other data, reservation manager objects, agent states, and computed paths.

In some implementations, the coordinator server and/or the warehouse server may include specialized processing units such as graphics processing units (GPUs) or field-programmable gate arrays (FPGAs) to accelerate pathfinding computations and conflict detection algorithms. The coordinator server may also incorporate load balancing mechanisms to distribute computational tasks across multiple processing cores or nodes when operating in a distributed configuration.

The communication interfaces of the coordinator server and/or the warehouse server may include network interface controllers, wireless transceivers, and protocol stacks supporting various communication standards. In some aspects, the coordinator server may maintain connection pools and message queues to handle concurrent requests from multiple robot managers or warehouse execution systems. The coordinator server may implement caching mechanisms to store frequently accessed path segments, heuristic calculations, and environmental data to reduce computational overhead during iterative planning cycles.

In some implementations, the coordinator server may include monitoring and logging subsystems that track system performance metrics such as planning computation times, path quality measures, and conflict resolution statistics. The coordinator server may also incorporate fault tolerance mechanisms including redundant processing capabilities, automatic failover systems, and data backup procedures to maintain operational continuity in case of hardware or software failures.

The memory architecture of the coordinator server may be organized into distinct regions for storing different types of data, including dedicated memory spaces for reservation manager objects, agent state information, environmental maps, and computed path solutions. In some aspects, the coordinator server may utilize memory management techniques such as garbage collection, memory pooling, and cache optimization to maintain efficient memory utilization during high-throughput operations.

The reservation manager objects may be implemented as data structures stored in memory that maintain mappings between spatial locations, time intervals, and agent identifiers. In some aspects, these data structures may comprise hash tables, arrays, linked lists, trees, or other suitable data organization methods that enable efficient lookup and modification of reservation information. The reservation manager objects may store state information including coordinates, orientations, velocities, and temporal data associated with agent movements.

The pathfinding processes disclosed herein may be implemented using various search techniques including A* search algorithm, Dijkstra's algorithm, breadth-first search, depth-first search, other graph traversal methods, or other suitable search algorithms. The heuristic functions may comprise distance-based calculations such as Manhattan distance, Euclidean distance, or more complex cost estimation functions that account for agent kinematics, orientation requirements, and environmental constraints.

The communication between system components may be implemented using various protocols including TCP/IP, UDP, HTTP, HTTPS, WebSocket, MQTT, or other network communication standards. The wireless communication may utilize Wi-Fi, Bluetooth, cellular networks, radio frequency protocols, or other wireless technologies suitable for transmitting control commands and status information.

The grid-based environment representation may be determined and implemented using various coordinate systems and discretization schemes. The grid cells may correspond to physical locations with dimensions ranging from centimeters to meters depending on the application requirements. The state representation of agents may include position coordinates, orientation angles, velocity components, and other kinematic parameters relevant to the specific agent type.

The iterative planning processes may incorporate various stopping criteria including maximum iteration counts, convergence thresholds, time limits, or solution quality metrics. The conflict detection mechanisms may evaluate various types of spatial and temporal overlaps including occupancy conflicts, edge conflicts, following conflicts, and other interference patterns based on agent dimensions and motion characteristics.

The distributed planning system may be implemented across multiple computing nodes, processors, or cores to enable parallel processing of agent subsets. The partitioning schemes may utilize spatial division, agent clustering, task-based grouping, or other methods for distributing computational load while maintaining coordination effectiveness.

The autonomous agents may include various types of robotic systems such as autonomous mobile robots (AMRs), automated guided vehicles (AGVs), autonomous vehicles, drones, humanoid robots, or other mobile platforms capable of receiving and executing motion commands. These machines may be equipped with sensors including cameras, lidar, ultrasonic sensors, encoders, inertial measurement units, or other perception systems for navigation and obstacle detection.

The autonomous agents may include various structural components and subsystems that enable autonomous navigation and task execution. In some implementations, these machines may comprise a chassis or frame structure that provides mechanical support for onboard systems and payload capacity for transporting materials, packages, or other cargo. The chassis may be constructed from materials such as steel, aluminum, carbon fiber, or composite materials to provide adequate strength while minimizing weight.

The propulsion system of an autonomous agent may include electric motors, drive wheels, steering mechanisms, and power transmission components. In some aspects, the machines may utilize differential drive systems with independently controlled wheels, omnidirectional drive systems with mecanum wheels or omni-wheels, or Ackermann steering configurations similar to conventional vehicles. The propulsion system may be powered by rechargeable battery packs, which may include lithium-ion, lithium-polymer, or other suitable battery technologies with integrated battery management systems for monitoring charge levels, temperature, and health status.

The navigation and sensing subsystems may comprise multiple sensor modalities for environmental perception and localization. In some implementations, these may include laser rangefinders or lidar sensors for distance measurement and obstacle detection, camera systems for visual navigation and object recognition, ultrasonic sensors for close-proximity detection, and wheel encoders or inertial measurement units for odometry and motion tracking. The machines may also incorporate magnetic sensors, RFID readers, global positioning system (GPS) chips, or barcode scanners for interacting with infrastructure elements or identifying specific locations within the operational environment.

The onboard computing systems may include one or more microprocessors, microcontrollers, or embedded computing platforms that execute navigation algorithms, sensor fusion routines, and communication protocols. In some aspects, these computing systems may include dedicated processing units for specific functions such as image processing, sensor data filtering, or real-time control loops. The machines may also incorporate memory storage for maps, configuration parameters, and operational data.

The communication subsystems may enable wireless connectivity with external systems such as warehouse management systems, coordinator servers, or other machines in the fleet. In some implementations, these may include Wi-Fi transceivers, cellular modems, Bluetooth modules, or proprietary radio frequency communication systems. The machines may also support wired communication interfaces such as Ethernet ports for configuration, diagnostics, or charging station interactions.

Safety systems may be integrated throughout the machine architecture to ensure safe operation in environments with human workers and other equipment. In some aspects, these may include emergency stop mechanisms, collision avoidance systems, warning lights and audible alarms, and fail-safe behaviors that bring the machine to a controlled stop in case of system failures. The machines may also incorporate physical bumpers, protective covers, or other mechanical safety features.

The payload handling systems may vary depending on the specific application requirements. In some implementations, AMRs and AGVs, for example, may include lifting mechanisms such as scissor lifts, conveyor systems for automated loading and unloading, robotic arms for manipulation tasks, or specialized fixtures for securing specific types of cargo. These systems may be actuated by electric motors, pneumatic cylinders, or hydraulic systems depending on the force and precision requirements.

Machine readable storage including machine-readable instructions, when executed, to implement a method or realize an apparatus in any of the examples of the present disclosure. Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The warehouse server and/or coordinator server (or other base station) and agents (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

Reference throughout this specification to “an example” means that a particular feature, structure, or characteristic described in connection with the example is included in at least one implementation of the present disclosure. Thus, appearances of the phrase “in an example” in various places throughout this specification are not necessarily all referring to the same implementation.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various implementations and examples of the present disclosure may be referred to herein along with alternatives for the various components thereof. It is understood that such implementations, examples, and alternatives are not to be construed as de facto equivalents of one another, but are to be considered as separate and autonomous representations of the present disclosure.

Several implementations have been described. Various modifications may be made without departing from the spirit and scope of the description. For example, various forms of the flow charts shown above may be used, with steps re-ordered, added, or removed. Accordingly, other implementations are within the scope of the following claims.

What is claimed:

1. A method of operating a route planning system for autonomous mobile machines, comprising:
receiving, at a warehouse server, a plurality of states and tasks assigned to a plurality of autonomous mobile machines;
transmitting from the warehouse server to a coordinator server, the plurality of states and tasks assigned to the plurality of autonomous mobile machines;
receiving at the coordinator server, the plurality of states and tasks assigned to the plurality of autonomous mobile machines;
initializing, at the coordinator server, at least two reservation manager objects;
iteratively determining paths for one or more of the plurality of autonomous mobile machines, wherein paths for at least one iteration are used to determine paths for a later iteration;
storing in at least one of the at least two reservation manager objects, a set of paths for one or more of the plurality of autonomous mobile machines that were iteratively determined;
transmitting the set of paths for the one or more of the plurality of autonomous mobile machines from the coordinator server to the warehouse server;
transmitting from the warehouse server to the one or more of the plurality of autonomous mobile machines, the set of paths; and
causing the one or more of the plurality of autonomous mobile machines to move in accordance with the set of paths for at least one time period.

2. The method of claim 1, wherein the tasks may include a target destination and task priority.

3. The method of claim 1, wherein a reservation manager object of the at least two reservation manager objects comprises a map of reserved states and times of one or more of the plurality of autonomous mobile machines.

4. The method of claim 1, wherein the reservation manager objects comprise maps of reserved states and times of one or more of the plurality of autonomous mobile machines for different iterations of determining paths for the one or more of the plurality of autonomous mobile machines.

5. The method of claim 1, wherein one of the at least two reservation manager objects is a working reservation manager object and another one of the at least two reservation manager objects is a reference reservation manager object.

6. The method of claim 5, wherein the working reservation manager object comprises newly made reservations associated with the plurality of autonomous mobile machines and the reference reservation manager object comprises previously made reservations associated with the plurality of autonomous mobile machines.

7. The method of claim 1, further comprising:
iteratively determining, new paths for one or more of the plurality of autonomous mobile machines for a new planning horizon, wherein the new paths take into account one or more prior paths determined in prior iterations of the new planning horizon for the one or more of the plurality of autonomous mobile machines;
storing in one of the at least two reservation manager objects, a set of new paths for the one or more of the plurality of autonomous mobile machines;
transmitting the set of new paths from the coordinator server to the warehouse server;
transmitting from the warehouse server to the one or more of the plurality of autonomous mobile machines, the set of new paths; and
causing the one or more of the plurality of autonomous mobile machines to move in accordance with the set of new paths.

8. The method of claim 1, wherein iteratively determining the set of paths for the one or more of the plurality of autonomous mobile machines further comprises determining the paths for fewer than all of the one or more of the plurality of autonomous mobile machines.

9. The method of claim 1, wherein the iterative determination of the paths is stopped after a predetermined threshold quantity of iterations.

10. The method of claim 9, wherein when a path is not determined for an autonomous mobile machine of the one or more of the plurality of autonomous mobile machines, a previously determined path is assigned to the autonomous mobile machine.

11. The method of claim 1, wherein the iterative determination of the paths is stopped when no conflicting paths remain.

12. The method of claim 1, further comprising:
iteratively determining, new paths for one or more of the plurality of autonomous mobile machines for a new planning horizon, wherein the new paths take into account one or more prior paths determined in prior iterations of the new planning horizon for the one or more of the plurality of autonomous mobile machines;
storing in one of the at least two reservation manager objects, a set of new paths for the one or more of the plurality of autonomous mobile machines;
transmitting the set of new paths from the coordinator server to the warehouse server; and
transmitting from the warehouse server to the one or more of the plurality of autonomous mobile machines, one or more movement commands in accordance with the set of new paths.

13. A method of scaling operation of a route planning system for autonomous mobile machine, comprising:
determining a size of an environment for a plurality of autonomous mobile machines at a distributed coordinator server;
partitioning, at the distributed coordinator server, the environment for the plurality of autonomous mobile machines in accordance with predetermined criteria into a plurality of subset environments;
for at least two of the plurality of subset environments:
receiving, at a warehouse server, a plurality of states and tasks assigned to the plurality of autonomous mobile machines, and
transmitting from the warehouse server to a distributed coordinator server, the plurality of states and tasks assigned to the plurality of autonomous mobile machines;
receiving at the distributed coordinator server, the plurality of states and tasks assigned to the plurality of autonomous mobile machines for the at least two of the plurality of subset environments;
initializing, at the distributed coordinator server, a plurality of reservation manager objects for each of the at least two of the plurality of subset environments and a concurrent reservation manager to be shared among the plurality of subset environments;
iteratively determining paths for one or more of the plurality of autonomous mobile machines for the at least two of the plurality of subset environments;
storing in a reservation manager object for each of the at least two of the plurality of subset environments and the concurrent reservation manager object, a first set of paths for one or more of the plurality of autonomous mobile machines associated with a first one of the at least two of the plurality of subset environments and a second set of paths for one or more of the plurality of autonomous mobile machines associated with a second one of the at least two of the plurality of subset environments;
transmitting the first set of paths and the second set of paths from the distributed coordinator server to the warehouse server for at least two of the plurality of subset environments;
transmitting the first set of paths from the warehouse server to the one or more of the plurality of autonomous mobile machines associated with the first one of the at least two of the plurality of subset environments and transmitting the second set of paths from the warehouse server to the one or more of the plurality of autonomous mobile machines associated with the second one of the at least two of the plurality of subset environments; and
causing the one or more of the plurality of autonomous mobile machines associated with the first one of the at least two of the plurality of subset environments to move in accordance with the first set of paths and the one or more of the plurality of autonomous mobile machines associated with the second one of the at least two of the plurality of subset environments to move in accordance with the second set of paths.

14. A route planning system for autonomous mobile machines, comprising:
a processor; and
a memory device that stores a plurality of instructions, which when executed by the processor, causes the processor to be configured to:
receive, from a warehouse server, a plurality of states and tasks assigned to a plurality of autonomous mobile machines;
initialize at least two reservation manager objects;
iteratively determine paths for one or more of the plurality of autonomous mobile machines for a first planning horizon;
store in at least one of the at least two reservation manager objects, a set of paths for one or more of the plurality of autonomous mobile machines for the first planning horizon; and
transmit the set of paths from to the warehouse server to cause the one or more of the plurality of autonomous mobile machines to move in accordance with the set of paths for at least one time period within the first planning horizon.

15. The route planning system of claim 14, wherein the tasks may include a target destination and task priority for the plurality of autonomous mobile machines.

16. The route planning system of claim 14, wherein a reservation manager object of the at least two reservation manager objects comprises a map of reserved states and times of the plurality of autonomous mobile machines.

17. The route planning system of claim 14, wherein one of the at least two reservation manager objects is a working reservation manager object and another one of the at least two reservation manager objects is a reference reservation manager object.

18. The route planning system of claim 17, wherein the working reservation manager object comprises newly made reservations associated with the plurality of autonomous mobile machines and the reference reservation manager object comprises previously made reservations associated with the plurality of autonomous mobile machines.

19. The route planning system of claim 14, wherein the plurality of instructions further causes the processor to:
iteratively determine, new paths for one or more of the plurality of autonomous mobile machines for a second planning horizon, wherein the new paths take into account one or more prior paths of the second planning horizon for the one or more of the plurality of autonomous mobile machines;
store in one of the at least two reservation manager objects, a set of new paths for the one or more of the plurality of autonomous mobile machines; and
transmit the set of new paths to the warehouse server to cause the one or more of the plurality of autonomous mobile machines to move in accordance with the set of new paths for the second planning horizon.
